(19) United States
(12) Patent Application Publication
(10) Pub. No.: US 2026/0283149 A1
(43) Pub. Date: Sep. 24, 2026

(54) DEVELOPMENT AND APPLICATION OF SYNTHETIC INHIBITORS OF PHOTOSYNTHESIS

(71) Applicant: University of Florida Research Foundation, Incorporated, Gainesville, FL (US)

(72) Inventors: Gilles Basset, Gainesville, FL (US); Lauren Stutts, Gainesville, FL (US); Scott Latimer, Gainesville, FL (US)

(21) Appl. No.: 19/480,136

(22) PCT Filed: May 16, 2024
(86) PCT No.: PCT/US2024/029634

§ 371 Date: Oct. 30, 2025

Related U.S. Application Data
(60) Provisional application No. 63/503,377, filed on May 19, 2023.

(51) Int. Cl. A01N 35/06; A01N 49/00; A01P 13/00

(52) U.S. Cl. CPC A01N 35/06; A01N 49/00; A01P 13/00

(57) ABSTRACT

The subject matter described herein is directed to herbicidal compounds, herbicidal compositions, methods of inhibiting photosynthesis using an herbicidal compound or composition described herein, and methods of inhibiting growth using an herbicidal compound or composition described herein. Also described is the biosynthesis of methylated plastoquinone-9 and its acute toxicity for plants and cyanobacteria. Additionally, the herbicidal activity of structural analogues of methyl-plastoquinone-9 (Me-PQ-9), which also display acute phytotoxicity at similar or lower concentrations than commercial herbicides.

### CROSS-REFERENCE TO RELATED APPLICATION

This application claims the benefit of U.S. Provisional Application No. 63/503,377, filed May 19, 2023, which is incorporated herein by reference.

### STATEMENT REGARDING FEDERALLY SPONSORED RESEARCH OR DEVELOPMENT

This invention was made with government support under Grant Nos. 1712608 and 2216747 awarded by the National Science Foundation. The government has certain rights in the invention.

### BACKGROUND

Catalytic promiscuity, together with gene duplications and mutations, is thought to be one of the key molecular mechanisms that underlies the emergence of novel metabolic capabilities (Jensen R A “Enzyme recruitment in evolution of new function.” Annu. Rev. Microbiol. 30, 409-425 (1976); Carbonell P et al. “Origins of specificity and promiscuity in metabolic networks.” J. Biol. Chem. 286, 43994-44004 (2011)). In this model, substrate-ambiguous enzymes generate an array of products, some of which confer a selective advantage. Gene duplication and divergence then contribute to fixing the increase in fitness and to driving metabolic specialization. Moreover, evolution can also capture catalytic promiscuity in order to create metabolic switches, allowing cells to quickly respond to environmental changes (Jeffery C J “Molecular mechanisms for multitasking: recent crystal structures of moonlighting proteins.” Curr. Opin. Struct. Biol. 14, 663-668 (2004)). C-methyltransferases that catalyze pivotal ring methylation in the biosynthetic pathways of respiratory and photosynthetic quinones are one example of such enzymatic evolution. Some C-methyltransferases, such as bifunctional UbiE/MenG found in both eukaryotic and prokaryotic lineages, display activity with both demethyl-benzoquinols and demethyl-naphthoquinols, involved in biosynthesis of both ubiquinone and menaquinone. Other C-methyltransferases, such as those found in cyanobacteria and plastids, have evolved strict substrate specificity. C-methyltransferases in cyanobacteria and plastids have evolved specificity for demethyl-naphthoquinols.

### SUMMARY

In some aspects, the presently disclosed subject matter is directed to methods of inhibiting photosynthesis in a prokaryotic or eukaryotic organism capable of photosynthesis, wherein the method comprises:
contacting the prokaryotic or eukaryotic organism capable of photosynthesis with an effective amount of an herbicide compound comprising a compound of Formula I:

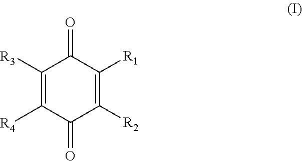

wherein,
   R¹ is halogen, C₁-C₆ alkyl, C₁-C₆ alkoxy, or substituted C₁-C₆ alkyl;
   R² is selected from the group consisting of: H, C₁-C₆ alkyl, substituted C₁-C₆ alkyl, C₂-C₅₀ alkenyl, and substituted C₂-C₅₀ alkenyl; and
   R³ and R⁴ are each independently selected from the group consisting of H, halogen, C₁-C₆ alkyl, substituted C₁-C₆ alkyl, C₁-C₆ alkoxy, substituted C₁-C₆ alkoxy, cycloalkyl, substituted cycloalkyl, heterocyclyl, substituted heterocycloalkyl, aryl, substituted aryl, heteroaryl, and substituted heteroaryl; or
   R³ and R⁴ together with the carbon atoms to which each is attached can come together to form a ring selected from the group consisting of C₃-C₁₀ cycloalkyl, substituted C₃-C₁₀ cycloalkyl, C₅-C₁₀ aryl, substituted C₅-C₁₀ aryl, C₃-C₁₀ heterocycloalkyl, substituted C₃-C₁₀ heterocycloalkyl, C₅-C₁₀ heteroaryl, and substituted C₅-C₁₀ heteroaryl.

In some aspects, the presently disclosed subject matter is directed to methods of inhibiting photosynthesis in a prokaryotic or eukaryotic organism capable of photosynthesis, wherein the method comprises:
contacting the prokaryotic or eukaryotic organism capable of photosynthesis with an effective amount of an herbicide compound comprising a compound of Formula I:

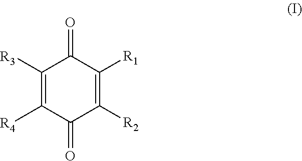

wherein,
   R¹ is Cl, methyl, or OCH₃;
   R² is selected from the group consisting of: H, CH₃, or [CH₂CHC(CH₃)CH₂]ₙH, wherein n is 1-10; and
   R³ is H or CH₃; and
   R⁴ is H, CH₃, OCH₃, or Cl.

In some embodiments,
(a) R¹, R², R³, and R⁴ are each CH₃;
(b) R¹, R³, and R⁴ are each CH₃, and R² is [CH₂CHC(CH₃)CH₂]₉H;
(c) R¹ is Cl and R², R³, and R⁴ are each H; or
(d) R¹ and R³ are each CH₃ and R² and R⁴ are each H.

In some aspects, the presently disclosed subject matter is directed to methods of controlling or inhibiting growth of a plant comprising:
contacting the plants with an effective amount of an herbicide compound comprising a compound of Formula I:

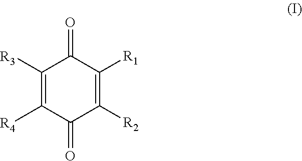

wherein,
   R¹ is halogen, C₁-C₆ alkyl, C₁-C₆ alkoxy, or substituted C₁-C₆ alkyl;
   R² is selected from the group consisting of: H, C₁-C₆ alkyl, substituted C₁-C₆ alkyl, C₂-C₅₀ alkenyl, and substituted C₂-C₅₀ alkenyl; and
   R³ and R⁴ are each independently selected from the group consisting of: H, halogen, C₁-C₆ alkyl, substituted C₁-C₆ alkyl, C₁-C₆ alkoxy, substituted C₁-C₆ alkoxy, cycloalkyl, substituted cycloalkyl, heterocyclyl, substituted heterocycloalkyl, aryl, substituted aryl, heteroaryl, and substituted heteroaryl; or
   R³ and R⁴ together with the carbon atoms to which each is attached can come together to form a ring selected from the group consisting of C₃-C₁₀ cycloalkyl, substituted C₃-C₁₀ cycloalkyl, C₅-C₁₀ aryl, substituted C₅-C₁₀ aryl, C₃-C₁₀ heterocycloalkyl, substituted C₃-C₁₀ heterocycloalkyl, C₅-C₁₀ heteroaryl, and substituted C₅-C₁₀ heteroaryl.

In some aspects, the presently disclosed subject matter is directed to methods of controlling or inhibiting growth of a plant comprising:
contacting the plants with an effective amount of an herbicide compound comprising a compound of Formula I:

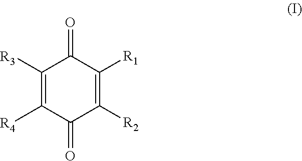

wherein,
   R¹ is Cl, methyl, or OCH₃;
   R² is selected from the group consisting of H, CH₃, or [CH₂CHC(CH₃)CH₂]ₙH, wherein n is 1-10; and
   R³ is H or CH₃; and
   R⁴ is H, CH₃, OCH₃, or Cl.

In some embodiments,
(a) R¹, R², R³, and R⁴ are each CH₃;
(b) R¹, R³, and R⁴ are each CH₃, and R² is [CH₂CHC(CH₃)CH₂]₉H;
(c) R¹ is Cl and R², R³, and R⁴ are each H; or
(d) R¹ and R³ are each CH₃ and R² and R⁴ are each H.

In some aspects, the presently disclosed subject matter is directed to methods of inhibiting germination of plant seed comprising:
contacting the seed or an environment around the seed with an effective amount of compound comprising a compound of Formula I:

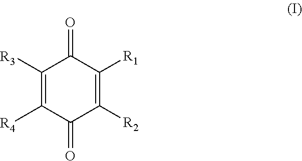

wherein,
   R¹ is halogen, C₁-C₆ alkyl, C₁-C₆ alkoxy, or substituted C₁-C₆ alkyl;
   R² is selected from the group consisting of: H, C₁-C₆ alkyl, substituted C₁-C₆ alkyl, C₂-C₅₀ alkenyl, and substituted C₂-C₅₀ alkenyl; and
   R³ and R⁴ are each independently selected from the group consisting of H, halogen, C₁-C₆ alkyl, substituted C₁-C₆ alkyl, C₁-C₆ alkoxy, substituted C₁-C₆ alkoxy, cycloalkyl, substituted cycloalkyl, heterocyclyl, substituted heterocycloalkyl, aryl, substituted aryl, heteroaryl, and substituted heteroaryl; or
   R³ and R⁴ together with the carbon atoms to which each is attached can come together to form a ring selected from the group consisting of C₃-C₁₀ cycloalkyl, substituted C₃-C₁₀ cycloalkyl, C₅-C₁₀ aryl, substituted C₅-C₁₀ aryl, C₃-C₁₀ heterocycloalkyl, substituted C₃-C₁₀ heterocycloalkyl, C₅-C₁₀ heteroaryl, and substituted C₅-C₁₀ heteroaryl.

In some aspects, the presently disclosed subject matter is directed to methods of inhibiting germination of plant seed comprising:
contacting the seed or an environment around the seed with an effective amount of compound comprising a compound of Formula I:

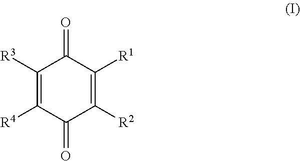

wherein,
   R¹ is Cl, methyl, or OCH₃;
   R² is selected from the group consisting of H, CH₃, or [CH₂CHC(CH₃)CH₂]ₙH, wherein n is 1-10; and
   R³ is H or CH₃; and
   R⁴ is H, CH₃, OCH₃, or Cl.

In some embodiments,
(a) R¹, R², R³, and R⁴ are each CH₃;
(b) R¹, R³, and R⁴ are each CH₃, and R² is [CH₂CHC(CH₃)CH₂]₉H;
(c) R¹ is Cl and R², R³, and R⁴ are each H; or
(d) R¹ and R³ are each CH₃ and R² and R⁴ are each H.

In some aspects, the presently disclosed subject matter is directed to a herbicidal compound (methyl-plastoquinone) comprising the following structure:

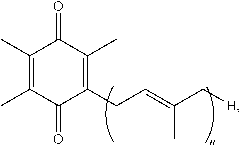

wherein n is 1-10.

In some aspects, the presently disclosed subject matter is directed to a herbicidal compound (methyl-plastoquinone-9) comprising the following structure:

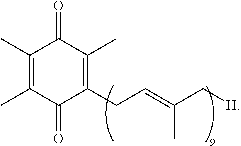

Additional aspects are also described herein.

### BRIEF DESCRIPTION OF THE DRAWINGS

FIG. 1. Benzoquinone and naphthoquinone ring methylations in the biosynthetic pathways of ubiquinone, menaquinone, and phylloquinone. (A) Prokaryotic UbiE/MenG and mitochondrial COQ5 catalyze the C-methylation of the intermediate 2-methoxy-6-all-trans-polyprenyl-1,4-benzoquinol (1) into 6-methoxy-3-methyl-2-all-trans-polyprenyl-1,4-benzoquinol (2) in the biosynthetic pathway of ubiquinone. (B) Prokaryotic UbiE/MenG and demethylphylloquinol methyltransferase (DPhQ-MT) catalyze the last step in the biosynthetic pathways of menaquinone and phylloquinone, respectively. R′, all trans prenyl moiety of variable length (e.g. R′=octaprenyl in E. Coli; R′=solanesyl in Arabidopsis). R″, prenyl moiety of variable length and unsaturation (e.g. R″=octaprenyl in E. Coli; R″=phytyl in plants). AdoMet, S-adenosyl-L-Methionine; AdoHcy, S-adenosyl-L-Homocysteine.

FIG. 2. Maximum-likelihood reconstruction of the phylogenetic relationships of quinone C-methyltransferases mined from prokaryotic and eukaryotic genomes using E. Coli UbiE/MenG as a query. The triangle marks the position of the outgroup. Dots indicate value ranges from an approximate likelihood-ratio test for branch support. Asterisks indicate that subcellular localization to the target organelle has been experimentally verified. Accession numbers and individual results from subcellular predictions algorithms are given in Table 2.

FIG. 3. Expression of Arabidopsis COQ5 in Synechocystis and Arabidopsis DPhQ-MT knockout mutants. (A), (B) Growth of Synechocystis DPhQ-MT knockout cells (Δsll1653) on BG-11 medium. EV, empty vector; tAtDPhQ-MT and tAtCOQ5, N-terminally truncated versions of Arabidopsis DPhQ-MT (At1g23360) and COQ5 (At5g57300), respectively. (C), (D), (E), (F) Ten day-old Arabidopsis AtDPhQ-MT knockout plants grown on MS medium with or without 1% (w/v) sucrose, and with or without 10 μM dexamethasone. pCOQ5-21 and pCOQ5-24 correspond to independent transgenic lines harboring plastid-targeted Arabidopsis COQ5 under the control of a dexamethasone-inducible promoter. EV, empty vector; Col-0, wild-type.

FIG. 4. Analyses of prenylated naphthoquinones in Synechocystis and Arabidopsis demethylphylloquinol methyltransferase knockout mutants. (A) Demethylphylloquinone (dPhQ) and phylloquinone (PhQ) content in Synechocystis cells grown photomixotrophically. (B) Demethylphylloquinone (dPhQ) and phylloquinone (PhQ) content in Arabidopsis rosette leaves. The nomenclature of Synechocystis strains and Arabidopsis transgenics is the same as that used in FIG. 3. Data are means of five biological replicates ±SE. n.d., not detected.

FIG. 5A-B. Analyses of plastoquinones in Synechocystis and Arabidopsis DPhQ-MT knockout mutants. (A) HPLC chromatograms with diode array (DAD 255 nm) and fluorimetric detections (FLD 290 nm/330 nm) corresponding to extracts of Synechocystis DPhQ-MT knockout mutant strain (Δsll1653)harboring either empty vector (EV, dashed trace) or Arabidopsis tCOQ5 expression construct (solid trace). C1, compound 1; C2, compound 2; plastoquinol-9 (PQ-9H₂); plastoquinone (PQ-9). (B) HPLC chromatograms with diode array and fluorimetric detections corresponding to extracts of Arabidopsis DPhQ-MT T-DNA knockout harboring either empty vector (EV, dashed trace) or plastid-targeted Arabidopsis COQ5 expression construct (pCOQ5-24, solid trace).

FIG. 5C-E. Analyses of plastoquinones in Synechocystis and Arabidopsis DPhQ-MT knockout mutants. (C) Structures of plastoquinone-9 and methyl-plastoquinone-9 (Compound 1) and their reduced versions plastoquinol-9 (PQ-9), plastoquinol-9 (PQ-9H₂), methyl-plastoquinol-9 (C2). R=solanesyl. (D), (E) Quantification of plastoquinone-9 (PQ-9), plastoquinol-9 (PQ-9H₂), methyl-plastoquinone-9 (Me-PQ-9), and methyl-plastoquinol 9 (Me-PQ-9H₂) in Synechocystis cells and Arabidopsis rosette leaves. Data are means of three to five biological replicates ±SE. n.d., not detected.

FIG. 6. Redox conversions of compound 1 into compound 3 and of plastoquinone-9 into plastoquinol-9. (A) HPLC chromatogram with diode array detection of purified compound land purified plastoquinone-9 before (solid black line) and after reduction with sodium borohydride (red dashed line). (B) HPLC chromatogram with fluorometric detection of purified compound 1 and purified plastoquinone-9 before (solid black line) and after reduction with sodium borohydride (red dashed line). (C) HPLC chromatogram with fluorometric detection of a leaf extract obtained from dexamethasone-induced pCOQ5-24 transgenics. Traces have been offset for clarity. C1, compound 1; C2, compound 2; plastoquinol-9 (PQ-9H₂); plastoquinone-9 (PQ-9).

FIG. 7. Liquid chromatography-mass spectrometry analyses of the ions of plastoquinone-9 and methyl-plastoguinone-9. (A) Structures of plastoquinone-9 and methyl-plastoquinone-9. (B) LCMS full scan total ion chromatographs of purified plastoquinone-9 (13.87 min) and of purified methyl-plastoquinone-9 (17.71 min). (C) Coupled all fragment ion scans contain the predicted adducts of plastoquinone-9, M+NH₄⁻ (766.6519 m/z), M+K⁺ (787.5806 m/z), and M+Na⁺ (771.6070 m/z) and methyl-plastoquinone-9, M+NH₄⁺ (780.6675 m/z) M+K⁺ (801.5964 m/z) and M+Na⁺ (785.6223 m/z).

FIG. 8. Chromatograms of the parent and daughter ions of plastoquinone-9 and methyl-plastoquinone-9. (A) LCMS single ion monitoring (SIM) chromatographs of the ammonium adducts of purified plastoquinone-9 (776.6514 m/z; 13.87 min) and methyl-plastoquinone-9 (780.667 m/z; 17.71 min). (B) Coupled data driven dMS2 scans contain the predicted daughter ions of plastoquinone-9 (151.0757 m/z) and methyl-plastoquinone-9 (165.0912 m/z).

FIG. 9. Tandem mass spectrometry analysis of plastoquinone-9 and methyl-plastoquinone-9. (A) Representative LCMS-MS (ESI) single reaction monitoring chromatographs of purified plastoquinone-9 and methyl-plastoquinone-9 from Arabidopsis, and purified plastoquinone-9 and methyl-plastoquinone-9 from Synechocystis. (B) Plastoquinone-9 was monitored in the positive ion mode with the [M+NH₄]⁺ parent ion at 766.6 m/za and ring containing daughter ion at 151 m/z. Methyl-plastoquinone-9 was monitored in the positive ion mode with the [M+NH₄]⁺ parent ion at 780.6 m/z and ring containing daughter ion at 165 m/z.

FIG. 10. Phenotype of Arabidopsis transgenics. One-month old plants grown at 110 μE m⁻² s⁻¹ (12-hour days, 22° C.) were sprayed daily with 20 μM dexamethasone and 0.02% (v/v) Silwet L-77 (+DEX) for four days. High-light treatment (800 μE m⁻² s⁻¹; 24-hour days) was started after the third spray. Dexamethasone was omitted in the control sprays.

FIG. 11. Growth inhibition of Arabidopsis and Synechocystis by duroquinone, the unprenylated structural analogue of methyl-plastoquinone-9. (A) Structure of duroquinone. (B) Seven-day-old Arabidopsis plants (Col-0) grown on MS medium containing 1% sucrose (w/v) and 0, 10, 25, 50, or 100 μM duroquinone in 12-hour days (110 μE m⁻² s⁻¹) at 22° C. (C) Growth curve of Synechocystis sp. PCC 6803 at 30° C. in liquid BG-11 medium containing glucose, and with or without duroquinone. Data are means of three biological replicates±SE. Asterisks indicate significant differences (0 μM vs. 10 μM duroquinone) as determined by Fisher's test (p<α=0.05) from an analysis of variance.

FIG. 12. Eleven-days old Arabidopsis plants were grown in 12-h days (110 μE m⁻²s⁻¹) at 22° C. on Murashige and Skoog medium containing various substituted benzoquinones.

FIG. 13. Growth inhibition of Synechocystis sp. PCC 6803 by structural analogues of methyl-plastoquinone-9. Synechocystis sp. PCC6803 cells were grown in liquid BG-11 medium containing mM glucose (80 μE m⁻² s⁻¹; 24-hour days; 30° C.). Cell growth was monitored spectrophotometrically at 700 nm.

FIG. 14. Structure of methylplastoquinone analogues: methylplastoquinone (MPG), Doruquinone (DQ), 2,6-dimethly-1,4-benzoquinone (DMBQ), 2,6-dimethoxy-1,4-benzoquinone (DMOBQ), 2,6-dichloro-1,4-benzoquinone (DCBQ), and 2-chloro-1,4-benzoquinone (CBQ). Methyl group at position R1 in MPQ indicates the methylated variant of the plastoquinone; polyisoprenoid C-45 side chain, R.

FIG. 15. Growth curve of Synechocystis treated with analogues grown photomixotrophically and photoautotrophically. Wild-type Synechocystis was grown in BG-11 and either with 5 mM glucose for photomixotrophic or w/o for photoautotrophic with treatment of either 0, 10 or 25 μM of the corresponding methylplastoquinone analog w/ 0.095% EtOH final and grown at a continuous light intensity of 50μ photons m⁻²s⁻¹ at 30° C. with shaking 125 rpm. Data are means of 2 biological replicates ±SD.

FIG. 16. Growth curve of E. coli and yeast treated with duroquinone. E. coli was grown in LB at 37° C. and yeast in YPD at 30° C. both with final 0.095% EtOH at either 0, 10 or 25 μM duroquinone with shaking at 245 rpm. Data are means of 2 biological replicates ±SD.

FIG. 17. Growth inhibition of Arabidopsis by structural analogues of methyl-plastoquinone-9. Ten days-old Arabidopsis plants (Col-0) grown on MS medium containing 1% sucrose (w/v), 0.095% EtOH and 0, 10, 25, 50 or 100 μM methyl-plastoquinone analogues in 12-h days (photon flux of 110 μmol m⁻²s⁻¹) at 22° C. 2,6-Dimethyl-1,4-benzoquinone, DMBQ; 2,6-Dimethoxy-1,4-benzoquinone, DMOBQ; 2,6-Dichloro-1,4-benzoquinone, DCBQ; 2-Chloro-1,4-benzoquinone, CBQ.

### DETAILED DESCRIPTION

The presently disclosed subject matter will now be described more fully. However, many modifications and other embodiments of the presently disclosed subject matter set forth herein will come to mind to one skilled in the art to which the presently disclosed subject matter pertains having the benefit of the teachings presented in the foregoing descriptions. Therefore, it is to be understood that the presently disclosed subject matter is not to be limited to the specific embodiments disclosed and that modifications and other embodiments are intended to be included within the scope of the appended claims. In other words, the subject matter described herein covers all alternatives, modifications, and equivalents. Unless otherwise defined, all technical and scientific terms used herein have the same meaning as commonly understood by one of ordinary skill in this field. All publications, patent applications, patents, and other references mentioned herein are incorporated by reference in their entirety. In the event that one or more of the incorporated literature, patents, and similar materials differs from or contradicts this application, including but not limited to defined terms, term usage, described techniques, or the like, this application controls.

### I. Overview

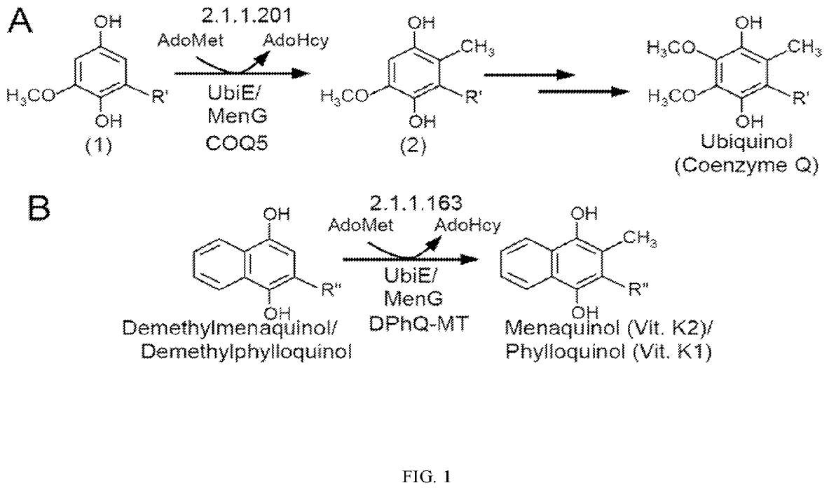

The bifunctional UbiE (EC 2.1.1.201)/MenG (EC 2.1.1.163) C-methyltransferase enzyme catalyzes ring methylations in the biosynthetic pathways of the electron carriers ubiquinone (Coenzyme Q, a benzoquinone) and menaquinone (vitamin K2, a naphthoquinone) in some prokaryotes (FIG. 1) (Lee P T et al. “A C-methyltransferase involved in both ubiquinone and menaquinone biosynthesis: isolation and identification of the Escherichia coli ubiE gene.” J. Bacteriol. 1997 179, 1748-1754 (1997)). This enzyme operates at a critical metabolic node, because bacteria must coordinate the respective proportions of ubiquinone, menaquinone, and its unmethylated precursor, demethylmenaquinone, depending on oxygen availability and carbon source (Bekker M et al. “Changes in the redox state and composition of the quinone pool of Escherichia coli during aerobic batch-culture growth.” Microbiology (Reading) 153, 1974-1980 (2007); Unden G “Differential roles for menaquinone and demethylmenaquinone in anaerobic electron transport of E. coli and their fnr-independent expression.” Arch. Microbiol. 150, 499-503 (1988); Soballe B et al. “Microbial ubiquinones: multiple roles in respiration, gene regulation and oxidative stress management.” Microbiology (Reading) 145, 1817-1830 (1999)).

Yeast and animals possess a homolog of prokaryotic UbiE/MenG called COQ5 (Barkovich R J et al. “Characterization of the COQ5 gene from Saccharomyces cerevisiae. Evidence for a C-methyltransferase in ubiquinone biosynthesis.” J. Biol. Chem. 272, 9182-9188 (1997); Nguyen T P et al. “Molecular characterization of the human COQ5 C-methyltransferase in coenzyme Q10 biosynthesis.” Biochim. Biophys. Acta 1841, 1628-1638 (2014)). The enzyme is targeted to mitochondria, where it contributes exclusively to the biosynthesis of ubiquinone (FIG. 1). The genome of Arabidopsis thaliana encodes two homologs of UbiE/MenG. The first one is a COQ5 ortholog (At5g57300), and complementation assays have shown that expression of this gene restored ubiquinone biosynthesis in a yeast coq5 knockout (Hayashi K et al. “Functional conservation of coenzyme Q biosynthetic genes among yeasts, plants, and humans.” PLoS One. 9, e99038 (2014)). High-throughput proteomics studies have consistently identified Arabidopsis COQ5 in highly purified mitochondria preparations (Heazlewood J L et al. “Experimental analysis of the Arabidopsis mitochondrial proteome highlights signaling and regulatory components, provides assessment of targeting prediction programs, and indicates plant-specific mitochondrial proteins.” Plant Cell 16, 241-256 (2004); Senkler J et al. “The mitochondrial complexome of Arabidopsis thaliana.” Plant J. 89, 1079-1092 (2017); Niehaus M et al. “Rapid Affinity Purification of Tagged Plant Mitochondria (Mito-AP) for Metabolome and Proteome Analyses.” Plant Physiol. 182, 1194-1210 (2020)). The second homolog (At1g23360) is targeted to plastids, where it catalyzes the methylation of demethylphylloquinol into phylloquinol (vitamin K1; FIG. 1), a structural analogue of menaquinone that serves as the A1 electron acceptor of photosystem I (Brettel K et al. “Flash-induced absorption changes in photosystem I at low temperature: evidence that the electron acceptor A1 is vitamin K1.” FEBS Letters. 203, 220-224 (1986); Lohmann A et al. “Deficiency in phylloquinone (vitamin K1) methylation affects prenyl quinone distribution, photosystem I abundance, and anthocyanin accumulation in the Arabidopsis AtmenG mutant.” J. Biol. Chem. 281, 40461-40472 (2006); Fatihi A et al. “A Dedicated Type II NADPH Dehydrogenase Performs the Penultimate Step in the Biosynthesis of Vitamin K1 in Synechocystis and Arabidopsis.” Plant Cell. 27, 1730-1741 (2015)). This enzyme, demethylphylloquinol methyltransferase (DPhQ-MT), is frequently referred to in the literature and in genomics databases as ‘MenG’ by reference to the authentic E. coli UbiE/MenG enzyme, although sensu stricto plants do not synthesize menaquinone (Lohmann A et al. 2006 and Fatihi A et al. 2015). Furthermore, in some plants, in particular non-photosynthetic parasitic species, DPhQ-MT orthologs lack a chloroplast transit peptide, and are targeted instead to the plasma membrane (Gu X et al. “Plasma membrane phylloquinone biosynthesis in nonphotosynthetic parasitic plants.” Plant Physiol. 185, 1443-1456 (2021)).

The inventors show that plants, unlike bacteria, do not exploit the catalytic versatility of quinone C-methyltransferases. It was posited that, since protein dual targeting to mitochondria and plastids is frequent in Angiosperms, including for phylloquinone biosynthesis (Xu L et al. “The dual targeting ability of type II NAD(P)H dehydrogenases arose early in land plant evolution.” BMC Plant Biol. 13, 100 (2013); Piller L E et al. “Chloroplast lipid droplet type II NAD(P)H quinone oxidoreductase is essential for prenylquinone metabolism and vitamin K1 accumulation.” Proc. Natl. Acad. Sci. U.S.A. 108, 14354-14359 (2011)), some taxa could have evolved a single bifunctional COQ5/DPhQ-MT that participates in both ubiquinone and phylloquinone biosynthesis. Alternatively, quinone C-methyltransferase orthologs might be targeted to mitochondria in some taxa and to plastids in others. Plant COQ5 or DPhQ-MT could also have evolved from different bacterial progenitors, via independent events of horizontal gene transfer, depending on the plant lineages. There are actually precedents for this scenario in the assembly and prenylation of the naphthoquinone moiety of phylloquinone in photosynthetic eukaryotes (Gross J et al. “Evidence of a chimeric genome in the cyanobacterial ancestor of plastids.” BMC Evol. Biol. 8, 117 (2008); Widhalm J R et al. “Phylloquinone (vitamin K(1)) biosynthesis in plants: two peroxisomal thioesterases of Lactobacillales origin hydrolyze 1,4-dihydroxy-2-naphthoyl-CoA.” Plant J. 71, 205-215 (2012)). Described herein is phylogenetic and biochemical evidence indicating that the evolutionary history of plant quinone C-methyltransferases rigidly correlate with their respective target organelles and function. Subsequent combination of reverse genetics and synthetic biology approaches in cyanobacteria and Arabidopsis demonstrates that oxygenic photosynthetic organisms have evolved unprecedented monofunctional DPhQ-MT, and explains the molecular basis of the selective force that drives this strict substrate specificity.

### II. Definitions

As used in the present specification, the following words, phrases, and symbols are generally intended to have the meanings as set forth below, except to the extent that the context in which they are used indicates otherwise.

As used herein, “and/or” refers to and encompasses any and all possible combinations of one or more of the associated listed items, as well as the lack of combinations when interpreted in the alternative (“or”).

As used herein, conditional language used herein, such as, among others, “can,” “could,” “might,” “may,” “e.g.,” and the like, unless specifically stated otherwise or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The prefix “Cn-Cm” indicates that the following group has from n to m carbon atoms. For example, “C₁-C₆ alkyl” indicates an alkyl group having from 1 to 6 carbon atoms.

Reference to “about” a value or parameter herein includes (and describes) embodiments that are directed to that value or parameter per se. In certain other embodiments, the term “about” includes the indicated amount ±20%. In certain other embodiments, the term “about” includes the indicated amount ±10%. In other embodiments, the term “about” includes the indicated amount ±5%. In certain other embodiments, the term “about” includes the indicated amount ±1%. In certain other embodiments, the term “about” includes the indicated amount ±0.5% and in certain other embodiments, 0.1%. Such variations are appropriate to perform the disclosed methods or employ the disclosed compositions. Also, to the term “about x” includes description of “x”.

The singular forms “a” and “the” include plural references unless the context clearly dictates otherwise. Thus, e.g., reference to “the compound” includes a plurality of such compounds and reference to “the assay” includes reference to one or more assays and equivalents thereof known to those skilled in the art.

“Alkyl” refers to an unbranched or branched saturated hydrocarbon chain. An alkyl group can have, for example, 1 to 20 carbon atoms (i.e., C₁-C₂₀ alkyl), 1 to 12 carbon atoms (i.e., C₁-C₁₂ alkyl), 1 to 8 carbon atoms (i.e., C₁-C₈ alkyl), 1 to 6 carbon atoms (i.e., C₁-C₆ alkyl), 1 to 4 carbon atoms (i.e., C₁-C₄ alkyl), or 1 to 3 carbon atoms (i.e., C₁-C₃ alkyl). Examples of alkyl groups include, but are not limited to, methyl, ethyl, propyl, isopropyl, n-butyl, sec-butyl, iso-butyl, tert-butyl, pentyl, 2-pentyl, isopentyl, neopentyl, hexyl, 2-hexyl, 3-hexyl, and 3-methylpentyl. When an alkyl residue having a specific number of carbons is named by chemical name or identified by molecular formula, all positional isomers having that number of carbons may be encompassed; thus, for example, “butyl” includes n-butyl (i.e., —(CH₂)₃CH₃), sec-butyl (i.e., —CH(CH₃)CH₂CH₃), isobutyl (i.e., —CH₂CH(CH₃)₂) and tert-butyl (i.e., —C(CH₃)₃); and “propyl” includes n-propyl (i.e., —(CH₂)₂CH₃) and isopropyl (i.e., —CH(CH₃)₂).

Unless indicated explicitly otherwise, where combinations of groups are referred to herein as one moiety, e.g., arylalkyl or aralkyl, the last mentioned group contains the atom by which the moiety is attached to the rest of the molecule.

“Alkenyl” refers to an unbranched or branched hydrocarbon chain having at least one carbon-carbon double bond. The group may be in either the cis or trans conformation about the double bond(s), and should be understood to include both isomers. An alkenyl group can have, for example, 2 to 50 carbon atoms (i.e., C₂-C₅₀ alkenyl), 2 to 20 carbon atoms (i.e., C₂-C₂₀ alkenyl), 2 to 12 carbon atoms (i.e., C₂-C₁₂ alkenyl), 2 to 8 carbon atoms (i.e., C₂-C₈ alkenyl), 2 to 6 carbon atoms (i.e., C₂-C₆ alkenyl), 2 to 4 carbon atoms (i.e., C₂-C₄ alkenyl), or 2 to 3 carbon atoms (i.e., C₂-C₃ alkenyl). Examples of alkenyl groups include, but are not limited to, ethenyl (—CH═CH₂), 1-propenyl (—CH₂CH═CH₂), isopropenyl (—C(CH₃)═CH₂), butenyl, 1,3-butadienyl, —CH₂CHC(CH₃)₂, —CH₂CHC(CH₃)CH₂—, and —[CH₂CHC(CH₃)CH₂]ₙH. Unless stated otherwise specifically in the specification, an alkenyl group is optionally substituted (i.e., contains one or more hydrogen substitutions).

“Alkoxy” refers to the group “alkyl-O—”. Examples of alkoxy groups include, but are not limited to, methoxy, ethoxy, n-propoxy, iso-propoxy, n-butoxy, tert-butoxy, sec-butoxy, n-pentoxy, n-hexoxy, and 1,2-dimethylbutoxy.

“Aryl” refers to an aromatic carbocyclic group having a single ring (e.g. monocyclic) or multiple rings (e.g., bicyclic or tricyclic) including fused systems. An aryl group can have, for example, 6 to 20 ring carbon atoms (i.e., C₆-C₂₀ aryl), 6 to 12 carbon ring atoms (i.e., C₆-C₁₂ aryl), or 6 to 10 carbon ring atoms (i.e., C₆-C₁₀ aryl). Examples of aryl groups include, but are not limited to, e.g., phenyl, naphthyl, fluorenyl and anthryl. Aryl, however, does not encompass or overlap in any way with heteroaryl defined below. If one or more aryl groups are fused with a heteroaryl, the resulting ring system is heteroaryl. If one or more aryl groups are fused with a heterocyclyl, the resulting ring system is heterocyclyl.

“Cycloalkyl” refers to a saturated or partially unsaturated cyclic alkyl group having a single ring or multiple rings including fused, bridged and spiro ring systems. The term “cycloalkyl” includes cycloalkenyl groups (i.e., the cyclic group having at least one double bond) and carbocyclic fused ring systems having at least one sp³ carbon atom (i.e., at least one non-aromatic ring). A cycloalkyl group can have, for example, 3 to 20 ring carbon atoms (i.e., C₃-C₂₀ cycloalkyl), 3 to 12 ring carbon atoms (i.e., C₃-C₁₂ cycloalkyl), 3 to 10 ring carbon atoms (i.e., C₃-C₁₀ cycloalkyl), 3 to 8 ring carbon atoms (i.e., C₃-C₆ cycloalkyl), 3 to 7 ring carbon atoms (i.e., C₃-C₇ cycloalkyl), or 3 to 6 ring carbon atoms (i.e., C₃-C₆ cycloalkyl). Monocyclic groups include, but are not limited to, cyclopropyl, cyclobutyl, cyclopentyl, cyclohexyl, cycloheptyl and cyclooctyl. Polycyclic groups include, for example, bicyclo[2.2.1]heptanyl, bicyclo[2.2.2]octanyl, adamantyl, norbornyl, decalinyl, 7,7-dimethyl-bicyclo[2.2.1]heptanyl and the like. Further, the term cycloalkyl is intended to encompass any non-aromatic ring which may be fused to an aryl ring, regardless of the attachment to the remainder of the molecule. Cycloalkyl also includes “spirocycloalkyl” when there are two positions for substitution on the same carbon atom, for example spiro[2.5]octanyl, spiro[4.5]decanyl, or spiro[5.5]undecanyl.

“Halogen” or “halo” refers to atoms occupying group VIIA of the periodic table, such as fluoro, chloro, bromo, and iodo.

“Heteroaryl” refers to an aromatic group having a single ring, multiple rings, or multiple fused rings, with one or more ring heteroatoms independently selected from nitrogen, oxygen, and sulfur. A heteroaryl includes, for example, 1 to 20 ring carbon atoms (i.e., C₁-C₂₀ heteroaryl), 3 to 12 ring carbon atoms (i.e., C₃-C₁₂ heteroaryl), or 3 to 8 carbon ring atoms (i.e., C₃-C₈ heteroaryl), and 1 to 5 ring heteroatoms, 1 to 4 ring heteroatoms, 1 to 3 ring heteroatoms, 1 to 2 ring heteroatoms, or 1 ring heteroatom independently selected from nitrogen, oxygen and sulfur. In certain instances, heteroaryl includes, but is not limited to, 9-10 membered ring systems (9- to 10-membered heteroaryl), 6-10 membered ring systems (6- to 10-membered heteroaryl), 5-10 membered ring systems (5- to 10-membered heteroaryl), 5-7 membered ring systems (5- to 7-membered heteroaryl), or 5-6 membered ring systems (5- to 6-membered heteroaryl), each independently having 1 to 4 ring heteroatoms, 1 to 3 ring heteroatoms, 1 to 2 ring heteroatoms, or 1 ring heteroatom independently selected from nitrogen, oxygen and sulfur. Examples of heteroaryl groups include, but are not limited to, acridinyl, benzimidazolyl, benzothiazolyl, benzindolyl, benzofuranyl, benzothiazolyl, benzothiadiazolyl, benzonaphthofuranyl, benzoxazolyl, benzothienyl (benzothiophenyl), benzotriazolyl, benzo[4,6]imidazo[1,2-a]pyridyl, carbazolyl, cinnolinyl, dibenzofuranyl, dibenzothiophenyl, furanyl, isothiazolyl, imidazolyl, indazolyl, indolyl, indazolyl, isoindolyl, isoquinolyl, isoxazolyl, naphthyridinyl, oxadiazolyl, oxazolyl, 1-oxidopyridinyl, 1-oxidopyrimidinyl, 1-oxidopyrazinyl, 1-oxidopyridazinyl, phenazinyl, phthalazinyl, pteridinyl, purinyl, pyrrolyl, pyrazolyl, pyridinyl, pyrazinyl, pyrimidinyl, pyridazinyl, quinazolinyl, quinoxalinyl, quinolinyl, quinuclidinyl, isoquinolinyl, thiazolyl, thiadiazolyl, triazolyl, tetrazolyl and triazinyl. Examples of the fused-heteroaryl rings include, but are not limited to, benzo[d]thiazolyl, quinolinyl, isoquinolinyl, benzo[b]thiophenyl, indazolyl, benzo[d]imidazolyl, pyrazolo[1,5-a]pyridinyl and imidazo[1,5-a]pyridinyl, where the heteroaryl can be bound via either ring of the fused system. Any aromatic ring, having a single or multiple fused rings, containing at least one heteroatom, is considered a heteroaryl regardless of the attachment to the remainder of the molecule (i.e., through any one of the fused rings). Heteroaryl does not encompass or overlap with aryl as defined above.

“Heterocyclyl” refers to a saturated or partially unsaturated cyclic alkyl group, with one or more ring heteroatoms independently selected from nitrogen, oxygen and sulfur. The term “heterocyclyl” includes, but is not limited to, heterocycloalkenyl groups (i.e., the heterocyclyl group having at least one double bond), bridged-heterocyclyl groups, fused-heterocyclyl groups and spiro-heterocyclyl groups. A heterocyclyl may be a single ring or multiple rings wherein the multiple rings may be fused, bridged or spiro, and may comprise one or more (e.g., 1 to 3) oxo (═O) or N-oxide (—O—) moieties. Any non-aromatic ring containing at least one heteroatom is considered a heterocyclyl, regardless of the attachment (i.e., can be bound through a carbon atom or a heteroatom). Further, the term heterocyclyl is intended to encompass any non-aromatic ring containing at least one heteroatom, which ring may be fused to an aryl or heteroaryl ring, regardless of the attachment to the remainder of the molecule. A heterocyclyl can have, for example, 2 to 20 ring carbon atoms (i.e., C₂-C₂₀ heterocyclyl), 2 to 12 ring carbon atoms (i.e., C₂-C₁₂ heterocyclyl), 2 to 10 ring carbon atoms (i.e., C₂-C₁₀ heterocyclyl), 2 to 8 ring carbon atoms (i.e., C₂-C₈ heterocyclyl), 3 to 12 ring carbon atoms (i.e., C₃-C₁₂ heterocyclyl), 3 to 8 ring carbon atoms (i.e., C₃-C₈ heterocyclyl), or 3 to 6 ring carbon atoms (i.e., C₃-C₆ heterocyclyl); having 1 to 5 ring heteroatoms, 1 to 4 ring heteroatoms, 1 to 3 ring heteroatoms, 1 to 2 ring heteroatoms, or 1 ring heteroatom independently selected from nitrogen, sulfur or oxygen. When the heterocyclyl ring contains 4- or 6-ring atoms, it is also referred to herein as a 4- or 6-membered heterocyclyl. When the heterocyclyl ring contains 5- to 7-ring atoms, it is also referred to herein as a 5- to 7-membered heterocyclyl. When the heterocyclyl ring contains 5- to 10-ring atoms, it is also referred to herein as a 5- to 10-membered heterocyclyl. Examples of heterocyclyl groups include, but are not limited to, e.g., azetidinyl, azepinyl, benzodioxolyl, benzo[b][1,4]dioxepinyl, 1,4-benzodioxanyl, benzopyranyl, benzodioxinyl, benzopyranonyl, benzofuranonyl, dioxolanyl, dihydropyranyl, hydropyranyl, thienyl[1,3]dithianyl, decahydroisoquinolyl, furanonyl, imidazolinyl, imidazolidinyl, indolinyl, indolizinyl, isoindolinyl, isothiazolidinyl, isoxazolidinyl, morpholinyl, octahydroindolyl, octahydroisoindolyl, 2-oxopiperazinyl, 2-oxopiperidinyl, 2-oxopyrrolidinyl, oxazolidinyl, oxiranyl, oxetanyl, phenothiazinyl, phenoxazinyl, piperidinyl, piperazinyl, 4-piperidonyl, pyrrolidinyl, pyrazolidinyl, quinuclidinyl, thiazolidinyl, tetrahydrofuryl, tetrahydropyranyl, trithianyl, tetrahydroquinolinyl, thiophenyl (i.e., thienyl), tetrahydropyranyl, thiomorpholinyl, thiamorpholinyl, 1-oxo-thiomorpholinyl and 1,1-dioxo-thiomorpholinyl. The term “heterocyclyl” also includes “spiroheterocyclyl” when there are two positions for substitution on the same carbon atom. Examples of the spiro-heterocyclyl rings include, but are not limited to, bicyclic and tricyclic ring systems, such as 2-oxa-7-azaspiro[3.5]nonanyl, 2-oxa-6-azaspiro[3.4]octanyl and 6-oxa-1-azaspiro[3.3]heptanyl. Examples of the fused-heterocyclyl rings include, but are not limited to, 1,2,3,4-tetrahydroisoquinolinyl, 4,5,6,7-tetrahydrothieno[2,3-c]pyridinyl, indolinyl and isoindolinyl, where the heterocyclyl can be bound via either ring of the fused system.

The terms “optional” or “optionally” means that the subsequently described event or circumstance may or may not occur and that the description includes instances where the event or circumstance occurs and instances in which it does not.

The term “substituted” when referring to any of the above described groups (i.e., alkyl, alkylene, alkoxy, haloalkyl, haloalkoxy, cycloalkyl, aryl, heterocyclyl, and/or heteroaryl) indicates that at least one (e.g., 1 to 5, 1 to 4, or 1 to 3) hydrogen atom is replaced by a bond to an atom or group (i.e., moiety) other than hydrogen. The atom or group can be, but is not limited to, alkyl, alkoxy, amino, aryl, aralkyl, carboxyl, carboxyl ester, cyano, cycloalkyl, halo, haloalkyl, haloalkoxy, hydroxyalkyl, heteroaryl, heterocyclyl, —NHNH₂, hydroxy, oxo, nitro, —S(O)OH, —S(O)₂OH, N-oxide or —Si(R^{y})₃, wherein each R^{y} is independently hydrogen, alkyl, alkenyl, alkynyl, heteroalkyl, cycloalkyl, aryl, heteroaryl or heterocyclyl. “Optionally substituted” when referring to a chemical group, indicates that one or more (e.g., 1 to 5, 1 to 4, or 1 to 3) hydrogen atoms on the designated atom or group may or may not be replaced by a moiety other than hydrogen.

In certain embodiments, “substituted” includes any of the above alkyl, alkenyl, alkynyl, cycloalkyl, heterocyclyl, aryl or heteroaryl groups in which one or more (e.g., 1 to 5, 1 to 4, or 1 to 3) hydrogen atoms are independently replaced with deuterium, halo, cyano, nitro, oxo, alkyl, haloalkyl, cycloalkyl, heterocyclyl, aryl, heteroaryl, —NR^{g}R^{h}, —NR^{g}C(═O)R^{h}, —NR^{g}C(═O)NR^{g}R^{h}, —NR^{g}C(═O)OR^{h}, —NR^{g}S(═O)₁₋₂R^{h}, —C(═O)R^{g}, —C(═O)OR^{g}, —OC(═O)OR^{g}, —OC(═O)R^{g}, —C(═O)NR^{g}R^{h}, —OC(═O)NR^{g}R^{h}, —OR^{g}, —SR^{g}, —S(═O)R^{g}, —S(═O)₂R^{g}, —OS(═O)₁₋₂R^{g}, —S(═O)₁₋₂OR^{g}, —NR^{g}S(═O)₁₋₂NR^{g}R^{h}, ═NSO₂R^{g}, ═NOR^{g}, —S(═O)₁₋₂NR^{g}R^{h}, —SF₅, —SCF₃ or —OCF₃. In certain embodiments, “substituted” includes any of the above groups in which one or more (e.g., 1 to 5, 1 to 4, or 1 to 3) hydrogen atoms are replaced with —C(═O)R^{g}, —C(═O)OR^{g}, —C(═O)NR^{g}R^{h}, —CH₂SO₂R^{g}, or —CH₂SO₂NR^{g}R^{h}. In the foregoing. R^{g} and R^{h} are the same or different and independently hydrogen, alkyl, alkoxy, aryl, cycloalkyl, haloalkyl, heterocyclyl, and/or heteroaryl. In certain embodiments, “substituted” included any of the above groups in which one or more (e.g., 1 to 5, 1 to 4, or 1 to 3) hydrogen atoms are replaced by a bond to an amino, cyano, hydroxyl, nitro, oxo, halo, alkyl, alkoxy, alkylamino, aryl, cycloalkyl, haloalkyl, heterocyclyl, N-heterocyclyl, heteroaryl, or two of R^{g} and R^{h} and Rⁱ are taken together with the atoms to which they are attached to form a heterocyclyl ring optionally substituted with oxo, halo or alkyl optionally substituted with oxo, halo, amino, hydroxyl, or alkoxy.

As used herein, the term “demethyl,” for example, in demethyl-benzoquinols, demethyl-naphthoquinols, refers to enzymatic substrates of C-methyltransferases lacking a methyl group, the addition of which is catalyzed by the enzyme.

The “environment of a prokaryotic or eukaryotic organism capable of photosynthesis” comprises the area surrounding the prokaryotic or eukaryotic organism capable of photosynthesis. The environment of the prokaryotic or eukaryotic organism capable of photosynthesis may be in proximity to, touching, adjacent to, or in the same field as the prokaryotic or eukaryotic organism capable of photosynthesis. The compositions described herein may be applied to the environment of the prokaryotic or eukaryotic organism capable of photosynthesis.

A “plant” refers to all plants, plant parts, seed, and plant populations, such as desirable and undesirable wild plants, cultivars, transgenic plants.

As used herein, the term “clade” refers to a group of organisms believed to have evolved from a common ancestor. On a phylogenetic tree, clade refers to a branch that includes a single common ancestor and all of its descendants.

As used herein, the term “homolog” or “homologous” refers to proteins and their encoding genes in different species that are similar in structure and evolutionary origin.

As used herein, the term “ortholog” refers to homologous proteins and their encoding genes in different species that evolved from a common ancestral gene, and, in general, orthologs retain the same function during the course of evolution.

As used herein, the term “paralog” refers to homologous proteins and their encoding genes in the same or different species that have diverged from each other as a consequence of genetic duplication.

As used herein, the term “photoautotroph,” or “photoautotrophic” or variations thereof refer to an organism's ability to use light energy and inorganic carbon sources to produce organic materials. Photoautotrophs are organisms that carry out photosynthesis.

As used herein, the term “photomixotroph,” “photomixotrophic,” or variations thereof refer to an organism's ability to simultaneously perform photosynthesis and metabolize imported organic substrates.

As used herein, the term “prenylated,” “prenylated moiety,” or variations thereof refer to the functional group

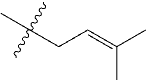 [SMILES: *CC=C(C)C]

or polymeric variations thereof. Prenylated moieties can comprise one or more of

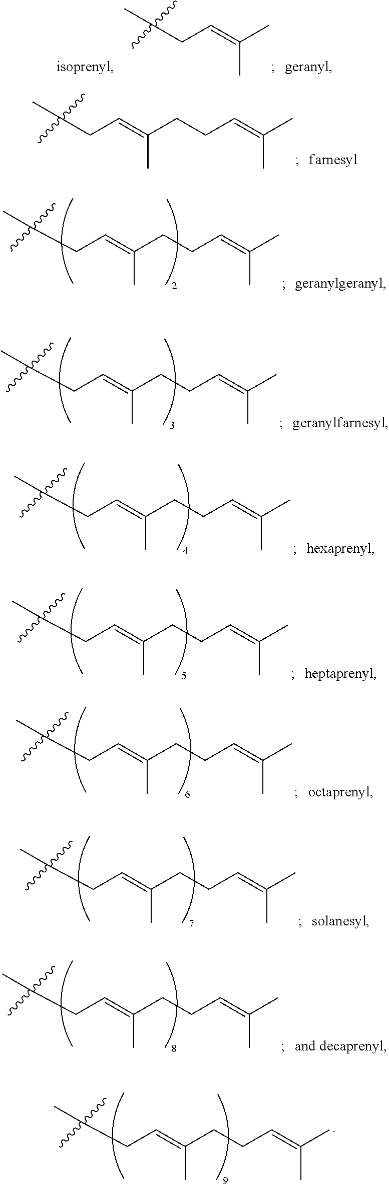

### III. Herbicide Compounds

Described herein are herbicide compounds. In some embodiments, the subject matter described herein is directed to an herbicide compound comprising a compound of Formula I:

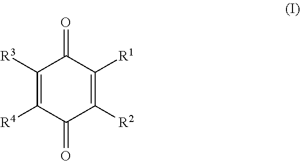

wherein,
   R¹ is halogen, C₁-C₆ alkyl, C₁-C₆ alkoxy, or substituted C₁-C₆ alkyl;
   R² is selected from the group consisting of: H, C₁-C₆ alkyl, substituted C₁-C₆ alkyl, C₂-C₅₀ alkenyl, and substituted C₂-C₅₀ alkenyl; and
   R³ and R⁴ are each independently selected from the group consisting of: H, halogen, C₁-C₆ alkyl, substituted C₁-C₆ alkyl, C₁-C₆ alkoxy, substituted C₁-C₆ alkoxy, cycloalkyl, substituted cycloalkyl, heterocyclyl, substituted heterocycloalkyl, aryl, substituted aryl, heteroaryl, and substituted heteroaryl; or
   R³ and R⁴ together with the carbon atoms to which each is attached can come together to form a ring selected from the group consisting of C₃-C₁₀ cycloalkyl, substituted C₃-C₁₀ cycloalkyl, C₅-C₁₀ aryl, substituted C₅-C₁₀ aryl, C₃-C₁₀ heterocycloalkyl, substituted C₃-C₁₀ heterocycloalkyl, C₅-C₁₀ heteroaryl, and substituted C₅-C₁₀ heteroaryl.

In some embodiments, the subject matter described herein is directed to an herbicide compound comprising a compound of Formula I:

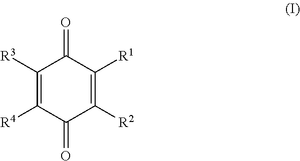

or an agriculturally acceptable salt thereof,
wherein,
   R¹ is methyl;
   R² is selected from the group consisting of: C₁-C₆ alkyl, substituted C₁-C₆ alkyl, C₂-C₅₀ alkenyl, and substituted C₂-C₅₀ alkenyl; and
   R³ and R⁴ are each independently selected from the group consisting of H, halogen, C₁-C₆ alkyl, substituted C₁-C₆ alkyl, C₁-C₆ alkoxy, substituted C₁-C₆ alkoxy, cycloalkyl, substituted cycloalkyl, heterocyclyl, substituted heterocycloalkyl, aryl, substituted aryl, heteroaryl, and substituted heteroaryl; or
   R³ and R⁴ together with the carbon atoms to which each is attached can come together to form a ring selected from the group consisting of C₃-C₁₀ cycloalkyl, substituted C₃-C₁₀ cycloalkyl, C₅-C₁₀ aryl, substituted C₅-C₁₀ aryl, C₃-C₁₀ heterocycloalkyl, substituted C₃-C₁₀ heterocycloalkyl, C₅-C₁₀ heteroaryl, and substituted C₅-C₁₀ heteroaryl.

In some embodiments, the subject matter described herein is directed to an herbicide compound comprising a compound of Formula I:

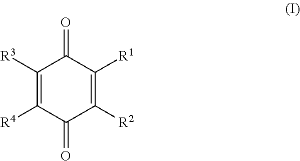

or an agriculturally acceptable salt thereof,
wherein,
   R¹ is methyl;
   R² is C₂-C₅₀ alkenyl or substituted C₂-C₅₀ alkenyl; and
   R³ and R⁴ are each independently selected from the group consisting of H, halogen, C₁-C₆ alkyl, substituted C₁-C₆ alkyl, C₁-C₆ alkoxy, substituted C₁-C₆ alkoxy, cycloalkyl, substituted cycloalkyl, heterocyclyl, substituted heterocycloalkyl, aryl, substituted aryl, heteroaryl, and substituted heteroaryl; or
   R³ and R⁴ together with the carbon atoms to which each is attached can come together to form a ring selected from the group consisting of C₃-C₁₀ cycloalkyl, substituted C₃-C₁₀ cycloalkyl, C₅-C₁₀ aryl, substituted C₅-C₁₀ aryl, C₃-C₁₀ heterocycloalkyl, substituted C₃-C₁₀ heterocycloalkyl, C₅-C₁₀ heteroaryl, and substituted C₅-C₁₀ heteroaryl.

In some embodiments, the subject matter described herein is directed to an herbicide compound comprising a compound of Formula I:

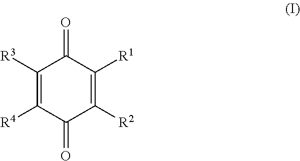

or an agriculturally acceptable salt thereof,
wherein,
   R¹ is methyl;
   R² is a substituted C₂-C₅₀ alkenyl, wherein the substituted C₂-C₅₀ alkenyl is a prenylated moiety; and
   R³ and R⁴ are each independently selected from the group consisting of H, halogen, C₁-C₆alkyl, substituted C₁-C₆ alkyl, C₁-C₆ alkoxy, substituted C₁-C₆ alkoxy, cycloalkyl, substituted cycloalkyl, heterocyclyl, substituted heterocycloalkyl, aryl, substituted aryl, heteroaryl, and substituted heteroaryl; or
   R³ and R⁴ together with the carbon atoms to which each is attached can come together to form a ring selected from the group consisting of C₃-C₁₀ cycloalkyl, substituted C₃-C₁₀ cycloalkyl, C₅-C₁₀ aryl, substituted C₅-C₁₀ aryl, C₃-C₁₀ heterocycloalkyl, substituted C₃-C₁₀ heterocycloalkyl, C₅-C₁₀ heteroaryl, and substituted C₅-C₁₀ heteroaryl.

In some embodiments, the subject matter described herein is directed to an herbicide compound comprising a compound of Formula I:

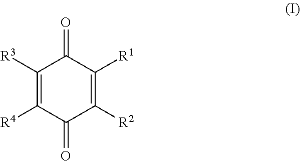

or an agriculturally acceptable salt thereof,
wherein,
   R¹ is methyl;
   R² is a prenylated moiety selected from the group consisting of isoprenyl, geranyl, farnesyl, geranylgeranyl, gemaylfamesyl, hexaprenyl, heptaprenyl, octaprenyl, solanesyl, and decaprenyl; and
   R³ and R⁴ are each independently selected from the group consisting of H, halogen, C₁-C₆ alkyl, substituted C₁-C₆ alkyl, C₁-C₆ alkoxy, substituted C₁-C₆ alkoxy, cycloalkyl, substituted cycloalkyl, heterocyclyl, substituted heterocycloalkyl, aryl, substituted aryl, heteroaryl, and substituted heteroaryl; or
   R³ and R⁴ together with the carbon atoms to which each is attached can come together to form a ring selected from the group consisting of C₃-C₁₀ cycloalkyl, substituted C₃-C₁₀ cycloalkyl, C₅-C₁₀ aryl, substituted C₅-C₁₀ aryl, C₃-C₁₀ heterocycloalkyl, substituted C₃-C₁₀ heterocycloalkyl, C₅-C₁₀ heteroaryl, and substituted C₅-C₁₀ heteroaryl.

In some embodiments, the subject matter described herein is directed to an herbicide compound comprising a compound of Formula I:

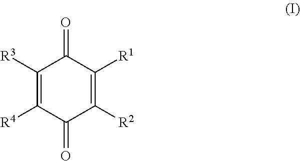

or an agriculturally acceptable salt thereof,
wherein,
   R¹ is methyl;
   R² is solanesyl; and
   R³ and R⁴ are each independently selected from the group consisting of H, halogen, C₁-C₆ alkyl, substituted C₁-C₆ alkyl, C₁-C₆ alkoxy, substituted C₁-C₆ alkoxy, cycloalkyl, substituted cycloalkyl, heterocyclyl, substituted heterocycloalkyl, aryl, substituted aryl, heteroaryl, and substituted heteroaryl; or
   R³ and R⁴ together with the carbon atoms to which each is attached can come together to form a ring selected from the group consisting of C₃-C₁₀ cycloalkyl, substituted C₃-C₁₀ cycloalkyl, C₅-C₁₀ aryl, substituted C₅-C₁₀ aryl, C₃-C₁₀ heterocycloalkyl, substituted C₃-C₁₀ heterocycloalkyl, C₅-C₁₀ heteroaryl, and substituted C₅-C₁₀ heteroaryl.

In some embodiments, the subject matter described herein is directed to an herbicide compound comprising a compound of Formula I:

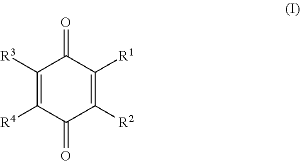

or an agriculturally acceptable salt thereof,
wherein,
   R¹ is methyl;
   R² is solanesyl; and
   R³ and R⁴ are each independently selected from the group consisting of H, halogen, C₁-C₆ alkyl, substituted C₁-C₆ alkyl, C₁-C₆ alkoxy, substituted C₁-C₆ alkoxy, cycloalkyl, substituted cycloalkyl, heterocyclyl, substituted heterocycloalkyl, aryl, substituted aryl, heteroaryl, and substituted heteroaryl.

In some embodiments, the subject matter described herein is directed to an herbicide compound comprising a compound of Formula I:

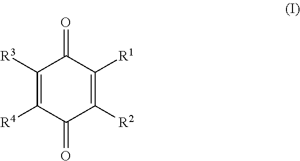

or an agriculturally acceptable salt thereof,
wherein,
   R¹ is methyl;
   R² is solanesyl; and
   R³ and R⁴ are each methyl.

In some embodiments, the subject matter described herein is directed to an herbicide compound comprising a compound of Formula I:

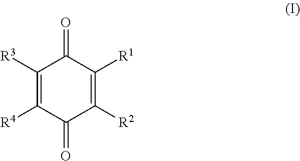

or an agriculturally acceptable salt thereof,
wherein,
   R¹ is methyl or a halogen; and
   at least two of R², R³, and R⁴ are methyl or halogen.

In some embodiments, the subject matter described herein is directed to an herbicide compound, or an agriculturally acceptable salt thereof, having the following structure:

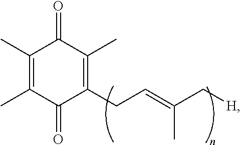

wherein n is 1-10.

In some embodiments, the subject matter described herein is directed to an herbicide compound, or an agriculturally acceptable salt thereof, having the following structure:

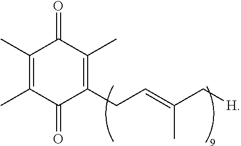

### IV. Herbicidal Compositions

Any of the described compounds of formula I can be provided in a composition or formulation. Any of the described compounds of formula I can be combined with one or more agriculturally acceptable adjuvant (i.e., excipients), one or more agrochemically active compounds, one or more biocontrol agents, or combinations thereof.

Described herein are herbicidal compositions. In some embodiments, the subject matter described herein is directed to an herbicidal compositions comprising a compound of Formula I: [symbol]
or an agriculturally acceptable salt thereof,
wherein,
   R¹ is halogen, C₁-C₆ alkyl, C₁-C₆ alkoxy, or substituted C₁-C₆ alkyl;
   R² is selected from the group consisting of H, C₁-C₆ alkyl, substituted C₁-C₆ alkyl, C₂-C₅₀ alkenyl, and substituted C₂-C₅₀ alkenyl; and
   R³ and R⁴ are each independently selected from the group consisting of: H, halogen, C₁-C₆ alkyl, substituted C₁-C₆ alkyl, C₁-C₆ alkoxy, substituted C₁-C₆ alkoxy, cycloalkyl, substituted cycloalkyl, heterocyclyl, substituted heterocycloalkyl, aryl, substituted aryl, heteroaryl, and substituted heteroaryl; or
   R³ and R⁴ together with the carbon atoms to which each is attached can come together to form a ring selected from the group consisting of C₃-C₁₀ cycloalkyl, substituted C₃-C₁₀ cycloalkyl, C₅-C₁₀ aryl, substituted C₅-Cia aryl, C₃-C₁₀ heterocycloalkyl, substituted C₃-C₁₀ heterocycloalkyl, C₅-C₁₀ heteroaryl, and substituted C₅-C₁₀ heteroaryl, and
at least one agriculturally acceptable adjuvant, agrochemically active compound, or biocontrol agent.

Herbicidal compositions containing the herbicidal compound of Formula I as defined above, as well as formulations derived thereof, including concentrates of aqueous or non-aqueous solutions and of aqueous suspensions which require dilution prior to application, are all embodiments of the present invention and are all referred to hereafter by the term compositions. The compositions may contain the herbicidally active components mixture comprising one or more herbicidal compounds of Formula I in a range from 0.1% to 100% weight and may also contain at least one agriculturally acceptable adjuvant in liquid or solid form. The herbicidally active components mixture may comprise at least one herbicidal compound of Formula I, one or more co-herbicides, and at least one agriculturally acceptable adjuvant in liquid or solid form. The one or more co-herbicides can be selected from the group consisting of: urea herbicides imidazolinone herbicides, diphenyl ether herbicides, hydroxy benzonitrile herbicides, 2-(4-aryloxyphenoxy)alkanoic acid herbicides, carbamate and thiocarbamate herbicides, quaternary ammonium salt herbicides, flupoxam, phytohormone herbicides, aryloxyalkanoic acid herbicides, arenecarboxylic acid herbicides, pyridinecarboxylic acid herbicides, pyridyloxyacetic acid herbicides, 2,6-dinitroaniline herbicides, amide herbicides, and anilide herbicides.

In some embodiments, compositions comprising the described herbicidal components may be present in free form or in the form of an agriculturally acceptable acid addition salt, complex, or association product, such as for example, a complex or association product formed with metal ions.

An agriculturally acceptable adjuvant (i.e., excipient) is any ingredient that is intentionally added to the formulation but is not itself expected to exert an effect on plant growth or health. Excipients may act to (a) aid in manufacture, (b) protect, support or enhance stability, plant delivery, or bioavailability, (c) assist in product identification, and/or (d) enhance any other attribute of the overall safety, effectiveness, or delivery or the composition during storage or use. An excipient may or may not be an inert substance. In some embodiments, the excipient is an agriculturally acceptable excipient. An excipient can be, but is not limited to, a carrier, an adjuvant, a solubilizing agent, a suspending agent, a diluent, an oxygen scavenger, an antioxidant, a food material, an anti-contaminant agent, or combinations thereof. Excipients include, but are not limited to: absorption enhancers, adhesives, anti-foaming agents, anti-oxidants, binders, buffering agents, carriers, coating agents, colors, delivery enhancers, dextran, dextrose, diluents, disintegrants, dispersants, dust control agents, emulsifiers, extenders, fillers, flavors, glidants, humectants, lubricants, oils, polymers, preservatives, saline, salts, solvents, sugars, suspending agents, sustained release matrices, sweeteners, thickening agents, tonicity agents, vehicles, water-repelling agents, and wetting agents. Excipients also include, cellulose, microcrystalline cellulose, lactose, sodium citrate, calcium carbonate, dibasic calcium phosphate, glycine, polysaccharides, starch, milk sugar, and high molecular weight polyethylene glycols, and the like. A carrier can be, but is not limited to, a solvent or dispersion medium containing, for example, water, saline, phosphate buffered saline, gel, solvent, solubilizer, alcohol. polyol (for example, glycerol, propylene glycol, and liquid polyethylene glycol), silicon, waxes, petroleum jelly, vegetable oil, sugar, gelatin, amylose, talc, surfactants, and suitable mixtures thereof. A carrier may also contain adjuvants or additives such as preservatives, wetting agents, emulsifying agents and dispersing agents. In some embodiments, the carrier is an agriculturally acceptable carrier. Agriculturally acceptable refers to those properties and/or substances which are acceptable for use in agriculture.

An agrochemically active compound is a substance that may be used for treating a seed, a plant, plant part, or the environment of the seed or plant or plant part. Agrochemically active compounds include, but are not limited to, fungicides, bactericides, insecticides, acaricides, nematicides, molluscicides, and herbicide safeners.

The described compound of formula I can be provided (formulated) as a liquid, a dispersion, a colloidal dispersion, a solution, a suspension, a colloidal suspension, an emulsion, a foam, a slurry, a lyophilized (freeze-dried) cake or powder, a spray-dried powder, a pellet, a biologically pure pellet, a coated pellet, a powder, a flowable powder, or a granule. A liquid formulation or composition may contain one or more of, a buffer, salt, sorbitol, and/or glycerol. The compound of formula I may be formulated as a heterogeneous mixture or a homogeneous mixture. Powders, pellets and granules may be formulated using encapsulation technologies known in the art.

The compositions are prepared by known techniques by admixing the herbicidally active ingredients with one or more adjuvants, including diluents, extenders, carriers, and conditioning agents, to provide compositions in the form of finely divided particulate solids, granules, pellets, solutions, dispersions, or emulsions. Thus the active ingredients can be used with an adjuvant such as a finely divided solid, a liquid of organic origin, water, a surfactant, a dispersing agent, an emulsifying agent, a stabilizing agent, an anti-freeze agent, an anti-foam agent, or any suitable combination of these.

Suitable solvents include water, alcohols (e.g. methanol, ethanol, n-propanol, isopropanol, ethylene glycol, etc.), ketones (e.g. acetone, methyl ethyl ketone, etc.), ethers (e.g. dioxane, tetrahydrofuran, ethylene glycol monomethyl ether, diethylene glycol monomethyl ether, propylene glycol monomethyl ether, etc.), aliphatic hydrocarbons (e.g. kerosene, lamp oil, fuel oil, machine oil, etc.), aromatic hydrocarbons (e.g. benzene, toluene, xylene, solvent naphta, methylnaphthalene, etc.), halogenated hydrocarbons (e.g. dichloromethane, chloroform, carbon tetrachloride, etc.), acid amides (e.g. dimethylformamide, dimethylacetamide, etc.), esters (e.g. ethyl acetate, butyl acetate, fatty acid glycerol ester, etc.), and nitriles (e.g. acetonitrile, propionitrile, etc.). These solvents may be used individually or in a suitable mixed form of two or more ingredients in a suitable ratio.

Examples of the solid carrier (diluent/extender) include vegetable powders (e.g. soybean meal: tobacco powder, wheat flour, sawdust, etc.), mineral powders (e g, clays such as kaolin bentonite, terra alba, talcs such as talcum powder and agalmotalite powder, and, silicas such as diatomaceous earth and mica powder), alumna, sulfur powder, and active carbon. These solid carriers may be used individually or in a suitable mixed form or two or more ingredients in a suitable ratio.

The above-mentioned liquid or solid vehicles (or carriers) can be used independently or in combination. An: amount of the Vehicle is in the range of up to 100% by weight of the whole composition.

Suitable surfactants include, but are not limited to, alkyl benzene sulfonates and alkyl naphthalene sulfonates, sulfated fatty alcohols, amines or acid amides, long chain acid esters of sodium isothionate, esters of sodium sulfosuccinate, sulfated or sulfonated fatty acid esters, petroleum sulfonates, sulfonated vegetable oils, ditertiary acetylenic glycols, polyoxyethylene derivatives of alkyl arylethers, polyoxyethylene derivatives of alkylphenols (particularly isooctylphenol and nonylphenol), and polyoxyethylene derivatives of the mono-higher fatty acid esters of hexitol anhydrides (e.g., sorbitan), polyoxyethylene allyl phenyl ether formaldehyde condensates, polyoxyethylene phenyl phenol ether sulfates. polyoxyethylene aryl ethers, alkoxylated amines, inorganic ammonium salts, such as ammonium sulphate, ammonium nitrate, and ammonium phosphates, ammonium salts derived from organic amines such as primary, secondary, and tertiary amines, diamines such as ethylene diamine and piperazine, morpholine, polyamines, alkoxylated amines, and amine surfactants, Preferred dispersants are methylcellulose, polyvinyl alcohol, sodium lignin sulfonates, polymeric alkyl naphthalene sulfonates, sodium naphthalene sulfonate, and polymethylene bisnaphthalene sulfonate.

Wettable powders are water-dispersible compositions containing the active ingredients mixture, an inert solid extender and one or more wetting and dispersing agents. The inert solid extenders are usually of mineral origin such as the natural clays, diatomaceous earth, and synthetic minerals derived from silica, and the like. Examples of such extenders include, but are not limited to, kaolinites, attapulgite clay, and synthetic magnesium silicate. The wettable powders compositions of this invention usually contain from above 0.5 to 60 parts (preferably 5 to 20 parts) of active ingredients mixture, from about 0.25 to 25 parts (preferably 1 to 15 parts) of wetting agent, from about 0.25 to about 25 parts (preferably 1 to 15 parts) of dispersant, and from 5 to about 95 parts (preferably 5 to 50 parts) of inert solid extender, all parts being by weight of the total composition. Where required, from about 0.1 to 2.0 parts of the solid inert extender can be replaced by a corrosion inhibitor or anti-foaming agent or both.

The compositions of the invention may be in the form of water dispersible granules (WG) comprising the herbicidally-active constituents together with surfactants, dispersing agents, disintegrating agents, fillers, diluents, and the like.

The compositions may also be formulated as dust concentrates comprising from 0.1 to 60% by weight of the active ingredients in admixture with a suitable extender or diluent; these dusts may be diluted for application at concentrations within the range of about 0.1 to about 10% weight.

Compositions which are aqueous suspensions or emulsions may be prepared by stirring a non-aqueous solution of a water insoluble active ingredients mixture and an emulsification agent with water until uniform and then homogenizing to give an emulsion of very finely divided particles. The resulting concentrated aqueous suspension is characterized by its extremely small particle size so that when diluted and sprayed, coverage is very uniform. Suitable concentrations of these formulations contain from about 0.1 to 60%, preferably 5 to 50%, by weight of active ingredients mixture, the upper limit being determined by the solubility limit of active ingredients in the solvent.

Concentrates are usually solutions of active ingredients mixtures in water-immiscible, partially water-miscible or water-miscible solvents together with a surface active agent. Suitable solvents for the active ingredients of this invention include dimethylformamide, dimethylsulfoxide, N-methyl-pyrrolidone, hydrocarbons, amines and water-immiscible ethers, esters, or ketones. However, other high strength liquid concentrates may be formulated by dissolving the active ingredient in a solvent then diluting, e.g., with kerosene, to spray concertation.

The concentrate compositions herein generally contain about 0.1 to 95 parts (preferably 5 to 60 parts) active ingredients mixture, about 0.25 to 50 parts (preferably 1 to 25 parts) surface active agent and where required about 4 to 94 parts solvent, all parts being by weight based on the total weight of emulsifiable oil.

The compositions of the invention can also be in the form of granules which are physically stable particulate compositions comprising active ingredient mixtures adhering to or distributed through a basic matrix of an inert, finely-divided particulate extender. In order to aid leaching of the active ingredient from the particulate, a surface-active agent such as those listed hereinbefore can be present in the composition. Natural clays, pyrophyllites, illite, and vermiculite are examples of operable classes of particulate mineral extenders. The preferred extenders are the porous, absorptive, preformed particles such as preformed and screened particulate attapulgite or heat expanded, particulate vermiculite, and the finely divided clays such as kaolin clays, hydrated attapulgite, or bentonitic clays. These extenders are sprayed or blended with the active ingredient to form the herbicidal granules.

The granular compositions of this invention ray contain from about 0.1 to 30 parts by weight of active ingredients mixture per 100 parts by weight of clay and 0 to about 5 parts by weight of surface-active agent per 100 parts by weight of particulate clay.

The compositions of this invention can also contain other additives for example, fertilizers, other herbicides, other pesticides, safeners, and other additives commonly used in herbicidal formulations, used as adjuvants, or in combination with any of the above-described adjuvants.

Suitable surfactants may be found in “Mc. Cutcheon's Detergents and Emulsifiers Annual”, Mc Publishing Corp., Ridgewood, N.J. or in equivalent technical documents.

In some embodiments, the compound of Formula I is formulated for application to a plant or plant part (e.g., a leaf).

### V. Methods

Described herein is a method of inhibiting photosynthesis in prokaryotic or eukaryotic organism capable of photosynthesis, wherein the method comprises contacting the prokaryotic or eukaryotic organism capable of photosynthesis with an effective amount of an herbicide compound comprising a compound of Formula I:

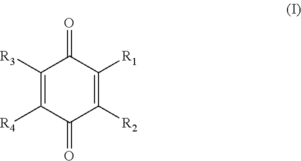

wherein,
   R¹ is halogen, C₁-C₆ alkyl, C₁-C₆ alkoxy, or substituted C₁-C₆ alkyl;
   R² is selected from the group consisting of: H, C₁-C₆ alkyl, substituted C₁-C₆ alkyl, C₂-C₅₀ alkenyl, and substituted C₂-C₅₀ alkenyl; and
   R³ and R⁴ are each independently selected from the group consisting of: H, halogen, C₁-C₆ alkyl, substituted C₁-C₆ alkyl, C₁-C₆ alkoxy, substituted C₁-C₆ alkoxy, cycloalkyl, substituted cycloalkyl, heterocyclyl, substituted heterocycloalkyl, aryl, substituted aryl, heteroaryl, and substituted heteroaryl; or
   R³ and R⁴ together with the carbon atoms to which each is attached can come together to form a ring selected from the group consisting of C₃-C₁₀ cycloalkyl, substituted C₃-C₁₀ cycloalkyl, C₅-C₁₀ aryl, substituted C₅-C₁₀ aryl, C₃-C₁₀ heterocycloalkyl, substituted C₃-C₁₀ heterocycloalkyl, C₅-C₁₀ heteroaryl, and substituted C₅-C₁₀ heteroaryl.

In some embodiments of the above method, R¹ is selected from the group consisting of methyl, ethyl, propyl, isopropyl, butyl, sec-butyl, tert-butyl, pentyl, and hexyl. In certain embodiments, R¹ is methyl.

In some embodiments of the above method, R² is C₁-C₆ alkyl or substituted C₁-C₆ alkyl. In certain embodiments, R² is selected from the group consisting of methyl, ethyl, propyl, isopropyl, butyl, sec-butyl, tert-butyl, pentyl, and hexyl. In some embodiments of the above method, R² is C₂-C₅₀ alkenyl or substituted C₂-C₅₀ alkenyl. In certain embodiments, R² is C₂-C₅₀ alkenyl substituted with one or more substituents selected from the group consisting of halogen, C₁-C₆ alkyl, and C₁-C₆ alkoxy. In certain embodiments, the one or more substituents is C₁-C₆ alkyl. In certain embodiments, the one or more substituents is methyl. In certain embodiments, R² is selected from the group consisting of isoprenyl, geranyl, farnesyl, geranylgeranyl, gemaylfamesyl, hexaprenyl, heptaprenyl, octaprenyl, solanesyl, and decaprenyl. In certain embodiments, R² is selected from the group consisting of octaprenyl, solanesyl, and decaprenyl. In certain embodiments, R² is solanesyl.

In some embodiments of the above method, R³ and R⁴ are each independently selected from the group consisting of halogen, C₁-C₆ alkyl, substituted C₁-C₆ alkyl, C₁-C₆ alkoxy, and substituted C₁-C₆ alkoxy. In certain embodiments, R³ and R⁴ are each independently C₁-C₆ alkyl or substituted C₁-C₆ alkyl. In certain embodiments, R³ and R⁴ are each independently selected from methyl, ethyl, propyl, isopropyl, butyl, sec-butyl, tert-butyl, pentyl, and hexyl. In certain embodiments, R³ and R⁴ are methyl.

In some embodiments of the above method, R³ and R⁴ and the carbon atoms to which each is attached come together to form a ring. In certain embodiments, the ring is selected from the group consisting of aryl, substituted aryl, heteroaryl, and substituted heteroaryl. In certain embodiments, the ring is aryl or substituted aryl. In certain embodiments, the ring is optionally substituted phenyl.

In some embodiments, the compound of Formula I or a composition or formulation comprising the compound is applied to the prokaryotic or eukaryotic organism capable of photosynthesis. The compound or a composition or formulation comprising the compound is applied to the prokaryotic or eukaryotic organism capable of photosynthesis in an amount effective inhibit photosynthesis in the prokaryotic or eukaryotic organism capable of photosynthesis or inhibit growth of the prokaryotic or eukaryotic organism capable of photosynthesis. In some embodiments, the compound, or a composition or formulation comprising the compound is applied to a plant or plant part. The compound or a composition or formulation comprising the compound is applied to the plant or plant part in an amount effective inhibit photosynthesis in the plant or inhibit growth of the plant.

The prokaryotic or eukaryotic organism capable of photosynthesis can be treated with any of the described compounds of Formula I. Treating includes any method of applying the compound or a composition or formulation comprising the compound to the prokaryotic or eukaryotic organism capable of photosynthesis.

In some embodiments, the compound of Formula I or a composition or formulation comprising the compound is applied to a plant, plant part in combination with one or more agrochemically active compounds, one or more biocontrol agents, or combinations thereof.

In some embodiments of the above method, the inhibition of photosynthesis inhibits growth of undesired prokaryotic or eukaryotic organism capable of photosynthesis. In certain embodiments, growth of the organism is inhibited by about 85% to about 100%. In certain embodiments, growth of the organism is inhibited by about 85%, 86%, 87%, 88%, 89%, 90%, 91%, 92%, 93%, 94%, 95%, 96%, 97%, 98%, 99%, or 100%. In certain embodiments, growth of the organism is inhibited by greater than 95%.

In some embodiments of the above method, the organism is a eukaryotic organism capable of photosynthesis. In certain embodiments, the organism is a plant.

In some embodiments of the above method, the organism is a prokaryotic organism capable of photosynthesis. In certain embodiments, the organism is a cyanobacteria. In certain embodiments, the organism is Synechocystis.

Also described herein is a method of controlling the growth of a plant in an area comprising: contacting the plant with an effective amount of an herbicide compound comprising a compound of Formula I as described above.

In some embodiments of the above method, the growth of the plant is inhibited by about 50% to about 100%. In some embodiments of the above method, the growth of the plant is inhibited by about 85% to about 100%. In certain embodiments, growth of the plant is inhibited by about 85%, 86%, 87%, 88%, 89%, 90%, 91%, 92%, 93%, 94%, 95%, 96%, 97%, 98%, 99%, or 100%. In certain embodiments, growth of the plant is inhibited by greater than 95%.

In some embodiments of the above method, the plant is in a crop field.

Also described herein is a method of inhibiting photosynthesis in a prokaryotic or eukaryotic organism capable of photosynthesis, wherein the method comprising: contacting the prokaryotic or eukaryotic organism capable of photosynthesis with an effective amount of an herbicide compound comprising the compound having the structure:

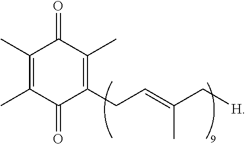

Also described herein is a method of inhibiting growth of a plant comprising:
contacting the plants with an effective amount of an herbicide compound comprising the compound having the structure:

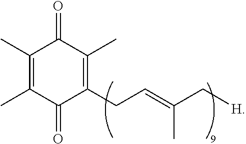

### EXAMPLES

### Materials and Methods

### I. Bioinformatics

Prokaryotic and eukaryotic homologs of E. coli UbiE/MenG were mined from fully sequenced genomes using BLASTp searches. Phylogenetic reconstructions were performed using the following tool suite from NGPhylogeny.fr (Lemoine F et al. “NGPhylogeny.fr: new generation phylogenetic services for non-specialists.” Nucleic Acids Res. 47, W260-W265 (2019)): MUSCLE (multiple alignment), Gblocks (removal of misaligned and divergent sequence regions), PhyML (tree inference via the maximum-likelihood method), Newick Display (tree rendering). Sterol methyltransferases from S. cerevisae (NP 013706.1) and A. thaliana (NP_001078579.1) served as outgroup. Branch support was assessed via approximate likelihood-ratio test (Anisimova M et al. “Approximate likelihood-ratio test for branches: A fast, accurate, and powerful alternative.” Syst. Biol. 55, 539-552 (2006)). Subcellular localizations were predicted using TARGETP-2.0 (Armenteros J J A et al. “Detecting sequence signals in targeting peptides using deep learning.” Life Sci. Alliance. 2, e201900429 (2019)), PREDOTAR (Small I et al. “Predotar: A tool for rapidly screening proteomes for N-terminal targeting sequences.” Proteomics. 4, 1581-1590 (2004)), WoLFPSORT (Horton P et al. “PSORT: protein localization predictor.” Nucleic Acids Res. 35, W585-587 (2007)), iPSORT (Bannai H et al. “Extensive feature detection of N-terminal protein sorting signals.” Bioinformatics. 18, 298-305 (2002)), and PredSL (Petsalaki El et al. “PredSL: a tool for the N-terminal sequence-based prediction of protein subcellular localization.” Genomics Proteomics Bioinformatics. 4, 48-55 (2006)).

### II. Chemical and Reagents

Standards of menaquinone-8, demethylmenaquinone-8 and ubiquinone-8 were prepared from E. coli K-12 extracts and HPLC-purified (Kim H U et al. “The AAE14 gene encodes the Arabidopsis o-succinylbenzoyl-CoA ligase that is essential for phylloquinone synthesis and photosystem-I function.” Plant J. 54, 272-283 (2008); Latimer S et al. 2021). Plastoquinone-9 and plastochromanol-8 were HPLC-purified from Arabidopsis thaliana leaf extracts (Block A et al. 2013). Demethylphylloquinone was extracted from the leaves of Arabidopsis thaliana DPhQ-MT knockout plants (GABI_565F06; 15) and HPLC-purified using the same method than that described for phylloquinone analysis in (Widhalm J R et al. 2012). Ubiquinone-9 and ubiquinone-10 were from Sigma-Aldrich. Phylloquinone was from MP Biomedicals. Quinol standards were prepared by reduction of their corresponding quinone forms with 20 mM NaBH4. Unless mentioned otherwise, other reagents were from Fisher Scientific.

### III. Functional Complementation of E. Coli

N-terminally truncated versions of cDNAs corresponding to Arabidopsis gene COQ5 (At5g57300) and DPhQ-MT (At1g23360) were prepared from Arabidopsis Col-0 total leaf RNAs using RT-PCR. N-terminally truncated S. cerevisiae COQ5 (E44→M44; YML110C) was PCR amplified from the genomic DNA of strain BY4741. E. coli gene ubiE/menG and Synechocystis DPhQ-MT (sll1653) were PCR amplified from the genomic DNA of E. coli K12 and Synechocystis sp. PCC 6803, respectively. All other DNAs were synthesized with codon optimization (Genescript, USA). Accession numbers of corresponding proteins and truncation positions are provided in Table 1 and Table 2 respectively. DNAs were cloned into EcoRI/XbaI-digested pBAD24 (Guzman L M et al. “Tight regulation, modulation, and high-level expression by vectors containing the arabinose PBAD promoter.” J. Bacteriol. 177, 4121-4130 (1995)) using. In-Fusion HD technology (Takara Bio), and introduced in E. coli ΔubiE778::kan (Keio strain JW5581-1; Baba T et al. “Construction of Escherichia coli K-12 in-frame, single-gene knockout mutants: the Keio collection.” Mol. Syst. Biol. 2, 2006.0008 (2006)). Keio strain JW5581-1 was obtained from Yale Cell Genetic Stock Center. Empty pBAD24 was used as a negative control. Transformed cells were selected on LB plates containing ampicillin (100 μg/ml) and kanamycin (50 μg/ml).

TABLE 1
Complementation of E. coli ΔubiE

pmoles/unit OD₆₀₀

| | Menaquinone-8 | Ubiquinone-8 |
|---|---|---|
| E. coli K12 | 11.7 ± 2.2 | 234.2 ± 20.9 |
| E. coli ΔubiE/MenG | n.d. | n.d. |

Clade 1

| | | |
|---|---|---|
| S. cerevisiae (E44→M44) | 96.3 ± 2.5 | 57.4 ± 2.8 |
| H. sapiens (E46→M46) | 320.8 ± 29.9 | 99.1 ± 8 |
| A. thaliana (S23→M23) | 102.4 ± 4.7 | 61.7 ± 9.6 |
| S. lycopersicum (S25→M25) | 101.1 ± 5.2 | 39.1 ± 1.6 |
| S. oleracea (R23→M23) | 150.1 ± 5 | 46.8 ± 1.9 |
| O. sativa (F29→M29) | 130.7 ± 5.7 | 97.2 ± 4.7 |
| A. trichopoda (F23→ M23) | 147.6 ± 5.4 | 91.2 ± 6 |
| S. moellendorfii (S24→M24) | 122.9 ± 1.6 | 74 ± 1.2 |
| P. patens (S36→M36) | n.d. | n.d. |
| O. tauri (S66→M66) | 128.1 ± 4.5 | 67.2 ± 0.8 |
| M. commoda (A33→M33) | n.d. | n.d. |
| E. coli | 91.5 ± 3.2 | 195.6 ± 9.7 |
| B. fragilis | 157.8 ± 17.4 | 55.9 ± 5.1 |
| A. aceti | 262 ± 9.2 | 48.7 ± 3.2 |
| D. radiodurans | 142 ± 10.5 | 53.5 ± 4.9 |
| C. Obscuribacteriales | 108.3 ± 6.6 | 16.2 ± 0.4 |

Clade 2

| | | |
|---|---|---|
| A. thaliana (V28→M28) | 25.2 ± 1.9 | n.d. |
| S. lycopersicum (L23→M23) | 29.9 ± 1.2 | n.d. |
| S. oleracea (I29→M29) | 44.4 ± 0.4 | n.d. |
| O. sativa (A29→M29) | 3.5 ± 0.8 | n.d. |
| A. trichopoda (S25→M25) | 21.4 ± 4 | n.d. |
| S. moellendorfii (A33→M33) | 52.3 ± 6.4 | n.d. |
| P. patens (G75→M75) | n.d. | n.d. |
| O. tauri (S60→M60) | n.d. | n.d. |
| M. commoda (S98→M98) | n.d. | n.d. |
| S. sp. PCC6803 | 12.5 ± 2.1 | n.d. |
| S. elongatus | 31.4 ± 0.9 | n.d. |

The positions of truncations of mitochondrial pre-sequences and plastid transit peptides are indicated in parentheses. Accession numbers are provided in Table 2. Data are means of three biological replicates ±SE. n.d., not detected.

TABLE 2
Accession numbers and predicted subcellular localizations of plant proteins used for phylogenetic reconstructions

| | | | | | | | |
|---|---|---|---|---|---|---|---|
| Organism | Accession | TARGETP | PREDOTAR | WoLFPSORT | iPSORT | PredSL | Consensus |

COQ5

| | | | | | | | |
|---|---|---|---|---|---|---|---|
| Rosids | | | | | | | |
| Arabidopsis thaliana | NP_200540.1 (*) | M | M | M | M | M | M |
| Citrus sinensis | XP_006474226.1 | M | M | M | M | M | M |
| Gossypium hirsutum | XP_016703271.2 | M | M | M | M | M | M |
| | XP_016712392.2 | M | M | M | M | M | M |
| Glycine max | NP_001242149.2 | M | — | M | M | M | M |
| | XP_003528301.1 | M | — | M | M | M | M |
| Cicer arietinum | XP_004506961.1 | M | M | M | M | M | M |
| Fragaria vesca | XP_011462347.1 | M | M | M | M | M | M |
| Malus domestica | XP_028955304.1 | M | — | M | M | M | M |
| | XP_028947261.1 | M | M | M | M | M | M |
| Morus notabilis | XP_010110721.2 | M | M | M | M | M | M |
| Hevea brasiliensis | XP_021680589.1 | M | M | M | M | M | M |
| Populus trichocarpa | XP_002324457.1 | M | M | M | M | M | M |
| Solanum lycopersicum | XP_004229541.1 (*) | M | M | M | M | M | M |
| Capsicum annuum | XP_016548520.1 | M | M | M | M | M | M |
| Nicotiana tabacum | XP_016464313.1 | M | M | M | M | M | M |
| | XP_016510061.1 | M | M | M | M | M | M |
| Olea europaea | XP_022863113.1 | M | M | M | M | M | M |
| Salvia splendens | XP_041991047.1 | M | — | M | M | M | M |
| | XP_041992880.1 | M | — | M | M | M | M |
| | XP_042033688.1 | M | M | M | M | M | M |
| | XP_042034289.1 | M | — | M | M | M | M |
| | XP_042043954.1 | M | — | M | M | M | M |
| Helianthus annuus | XP_021970541.1 | M | M | M | M | M | M |
| | XP_022037560.1 | M | M | M | M | M | M |
| Daucus carota | XP_017230501.1 | M | M | M | M | M | M |
| | XP_017237269.1 | M | M | M | M | M | M |
| Camellia sinensis | XP_028126800.1 | M | M | M | M | M | M |
| Caryophyllids | | | | | | | |
| Spinacia oleracea | XP_021845849.1 (*) | M | — | M | M | M | M |
| Chenopodium quinoa | XP_021727308.1 | M | M | M | M | M | M |
| | XP_021744984.1 | M | M | M | M | M | M |
| Monocots | | | | | | | |
| Oryza sativa | XP_015641142.1 (*) | M | M | M | M | M | M |
| Brachypodium | XP_003565194.1 | M | M | M | M | M | M |
| distachyon | | | | | | | |
| Triticum aestivum | XP_044326417.1 | M | M | M | M | M | M |
| | XP_044334633.1 | M | M | PM/ | M | M | M |
| | XP_044459307.1 | M | M | M | M | M | M |
| Sorghum bicolor | XP_021313011.1 | M | M | M | M | M | M |
| Setaria italica | XP_004978697.1 | M | M | M | M | M | M |
| Phoenix dactylifera | XP_038978469.1 | M | — | M/ER | M | M | M |
| Phalaenopsis | XP_020590833.1 | M | — | M | M | M | M |
| equestris | | | | | | | |
| Asparagus officinalis | XP_020272414.1 | M | — | M | M | M | M |
| Basal angiosperms | | | | | | | |
| Amborella trichopoda | XP_006845282.1 (*) | M | M | M | P | M | M |
| Lycophytes | | | | | | | |
| Selaginella | XP_024531053.1 (*) | M | M | M | M | M | M |
| moellendorffii | XP_002970249.1 | M | M | M | M | M | M |
| Bryophytes | | | | | | | |
| Physcomitrium patens | XP_024371637.1 (*) | M | M | P | M | M | M |
| Chlorophytes | | | | | | | |
| Chlamydomonas | XP_042924652.1 | M | M | M | M | M | M |
| reinhardtii | | | | | | | |
| Ostreococcus tauri | XP_003074478.1 (*) | M | M | M | M | M | M |
| Bathycoccus prasinos | XP_007515154.1 | M | — | N | M | M | M |
| Micromonas | XP_002507501.1 | M | M | P/C | — | M | M |
| commoda | | | | | | | |

DPhQ-MT

| | | | | | | | |
|---|---|---|---|---|---|---|---|
| Rosids | | | | | | | |
| Arabidopsis thaliana | NP_173750.3 (*) | P | P | P | P | P | P |
| Citrus sinensis | XP_006483908.1 | P | P | P | P | — | P |
| Gossypium hirsutum | XP_016701926.1 | P | — | P | P | M | P |
| | XP_016706726.1 | P | — | P | P | M | P |
| Glycine max | XP_003519807.1 | P | P | P | P | P | P |
| | XP_003517623.4 | — | — | P | M | M | none |
| Cicer arietinum | XP_004489801.1 | — | P | P | P | P | P |
| Fragaria vesca | XP_004299000.1 | P | P | P | P | P | P |
| | XP_004300930.1 | P | P | P | P | P | P |
| Malus domestica | XP_008340078.1 | P | P | P | P | P | P |
| | XP_008389690.1 | P | — | P | M | P | P |
| Morus notabilis | XP_010100423.1 | P | P | P | P | — | P |
| Hevea brasiliensis | XP_021692523.1 | P | P | P | P | M | P |
| Populus trichocarpa | XP_002312683.2 | P | P | P | P | E | P |
| Asterids | | | | | | | |
| Solanum lycopersicum | XP_004251986.1 (*) | P | — | P | P | P | P |
| Capsicum annuum | XP_016565363.1 | — | P | P | P | P | P |
| Nicotiana tabacum | XP_016506829.1 | — | — | N | M | E | none |
| | XP_016509937.1 | P | P | P | P | — | P |
| Olea europaea | XP_022887650.1 | P | P | P | P | M | P |
| Salvia splendens | XP_042004819.1 | P | P | P | P | M | P |
| | XP_042010950.1 | P | P | P | P | M | P |
| | XP_042020886.1 | P | P | M/P | P | M | P |
| | XP_042025215.1 | P | P | P | P | M | P |
| Helianthus annuus | XP_021998007.1 | — | P | P | P | P | P |
| Daucus carota | XP_017255586.1 | P | P | P | — | P | P |
| Camellia sinensis | XP_028115837.1 | P | — | P | P | P | P |
| Caryophyllids | | | | | | | |
| Spinacia oleracea | XP_021845805.1 (*) | P | P | P | P | P | P |
| Chenopodium quinoa | XP_021727074.1 | — | P | P | M | P | P |
| | XP_021743064.1 | — | P | P | M | P | P |
| Monocots | | | | | | | |
| Oryza sativa | XP_015636928 (*) | P | P | P | P | M | P |
| Brachypodium | XP_003580103.1 | P | P | P | P | P | P |
| distachyon | XP_003559950.2 | P | — | P | P | P | P |
| Triticum aestivum | XP_044333378.1 | — | — | P/E | P | E | none |
| | XP_044458145.1 | — | — | P | M | — | none |
| | XP_044458178.1 | P | P | P | P | P | P |
| Sorghum bicolor | XP_002448141.1 | P | — | P | P | M | P |
| Setaria italica | XP_004978697.1 | P | P | P | P | M | P |
| Phoenix dactylifera | XP_038976356.1 | — | P | P | P | M | P |
| | XP_038976802.1 | — | P | P | P | M | P |
| Phalaenopsis | XP_020585768 | P | P | P | P | P | P |
| equestris | | | | | | | |
| Asparagus officinalis | XP_020251477.1 | P | P | P | M | P | P |
| Basal angiosperms | | | | | | | |
| Amborella trichopoda | XP_020520855.1 (*) | P | — | N | P | P | P |
| Lycophytes | | | | | | | |
| Selaginella | XP_002963845.2 (*) | P | P | P | P | P | P |
| moellendorffii | XP_024532237.1 | P | P | P | P | P | P |
| Bryophytes | | | | | | | |
| Physcomitrium patens | XP_024374938.1 (*) | P | P | P | M | P | P |
| Chlorophytes | | | | | | | |
| Chlamydomonas | XP_001701914.1 | — | — | P | M | M | none |
| reinhardtii | | | | | | | |
| Ostreococcus tauri | XP_003080544.1 (*) | — | — | P | M | P | none |
| Bathycoccus prasinos | XP_007508360.1 | — | — | P | M | P | none |
| Micromonas | XP_002499598.1 | — | ER | P | M | M | none |
| commoda | | | | | | | |

Non-plant UbiE/MenG homologs

| | | | | | | | |
|---|---|---|---|---|---|---|---|
| Candidatus | MBY0549231.1 | N/A | N/A | N/A | N/A | N/A | N/A |
| Obscuribacterales | | | | | | | |
| Bacteroides fragilis | BAD47668.1 | N/A | N/A | N/A | N/A | N/A | N/A |
| Deinococcus | WP_010889031.1 | N/A | N/A | N/A | N/A | N/A | N/A |
| radiodurans | | | | | | | |
| Escherichia coli | YP_026269.1 | N/A | N/A | N/A | N/A | N/A | N/A |
| Acetobacter aceti | AQS85001.1 | N/A | N/A | N/A | N/A | N/A | N/A |
| Gloeobacter violaceus | BAC88068.1 | N/A | N/A | N/A | N/A | N/A | N/A |
| Synechococcus | BAD78640.1 | N/A | N/A | N/A | N/A | N/A | N/A |
| elongatus | | | | | | | |
| Pseudanabaena sp. | AFY69946.1 | N/A | N/A | N/A | N/A | N/A | N/A |
| PCC 7367 | | | | | | | |
| Acaryochloris marina | ABW28811.1 | N/A | N/A | N/A | N/A | N/A | N/A |
| Geitlerinema sp. PCC | AFY64881.1 | N/A | N/A | N/A | N/A | N/A | N/A |
| 7407 | | | | | | | |
| Lyngbya sp. PCC | WP_232228613.1 | N/A | N/A | N/A | N/A | N/A | N/A |
| 8106 | | | | | | | |
| Synechocystis sp. | BAA16833.1 | N/A | N/A | N/A | N/A | N/A | N/A |
| PCC 6803 | | | | | | | |
| Saccharomyces | NP_013597 (COQ5) | M | M | M | M | M | M |
| cerevisiae | | | | | | | |
| Homo sapiens | NP_115690 (COQ5) | — | M | M | — | M | M |

Consensus localization in mitochondria or plastids is bolded when three or more predictions were found congruent between TARGETP-2.0. PREDOTAR, WoLFPSORT, iPSORT, and PredSL. M, Mitochondrion; P, Plastid; ER, Endoplasmic reticulum; N, nucleus; C, cytosol; E, Extracellular; dashes, no prediction. Asterisks indicate the proteins selected for functional complementation assays in Escherichia coli.

### IV. Synechocystis Transformation and Arabidopsis Transgenics

For expression in Synechocystis, gene sll1653 and N-terminally truncated versions of At5g57300 (S23→M23) and At1g23360 (V28→M28) cDNAs were PCR amplified using primers that contained the NdeI(5′) and BglII(3′) restriction sites. PCR fragments were cloned into NdeI/BglII-digested pSynExp-2 expression vector (Sattler S E et al. “Characterization of tocopherol cyclases from higher plants and cyanobacteria. Evolutionary implications for tocopherol synthesis and function.” Plant Physiol. 132, 2184-2195 (2003)), and the resulting constructs were introduced into Synechocystis Δsll1653::aadA knockout cells (Lohmann A et al. 2006). Transformed cells were selected on BG-11 plates containing and chloramphenicol (5 g/ml), and spectinomycin (15 μg/ml) at 22° C. in 12-hour days (70 μE m⁻²s⁻¹). For growth assays, 3-weeks-old colonies were individually resuspended in 100 μl of BG11 medium, and serial dilutions were plated on BG-11 plates with or without 5 mM glucose. Plates were incubated in 12-hour days (70 μE m⁻²s⁻¹) for 14 days (photomixotrophic conditions) or 21 days (photoautotrophic conditions) at 22° C. For targeting of Arabidopsis COQ5 into plastids, a cDNA sequence corresponding to At5g57300, the predicted mitochondrial presequence (residues 1-23) of which had been replaced by the transit peptide (79 amino acids) of a small subunit of Arabidopsis RubisCO (At1g67090; RBCS1A) was synthesized and codon-optimized by Genescript, USA. This synthetic cDNA was subcloned using Gateway technology (Invitrogen) into binary expression vector pOpOn (Peer W A et al. “Mutation of the membrane-associated M1 protease APM1 results in distinct embryonic and seedling developmental defects in Arabidopsis.” Plant Cell 21, 1693-1721 (2009)). This construct and empty pOpOn control were transferred to Agrobacterium tumefaciens and then introduced into DPhQ-MT knockout line via floral dip. Transformants were selected on MS solid medium containing kanamycin (50 μg/ml) and 1% (w/v) sucrose. For induction of expression, dexamethasone was solubilized in DMSO and was used at the concentration of 10 μM for experiments conducted on plates or at 20 μM, together with Silwet L-77 adjuvant (0.02% v/v), for spray treatments on soil-grown plants. Dexamethasone was omitted for the control treatments. Culture conditions were 12-hour days (110 μE m⁻²s⁻¹) at 22° C. for both plants grown on plates and soil. Induction and analyses of chlorophyll fluorescence were performed on one month-old dark-adapted plants using a FluorCam 800 MF imaging system (Photon Systems Instruments).

### V. Metabolite Analyses

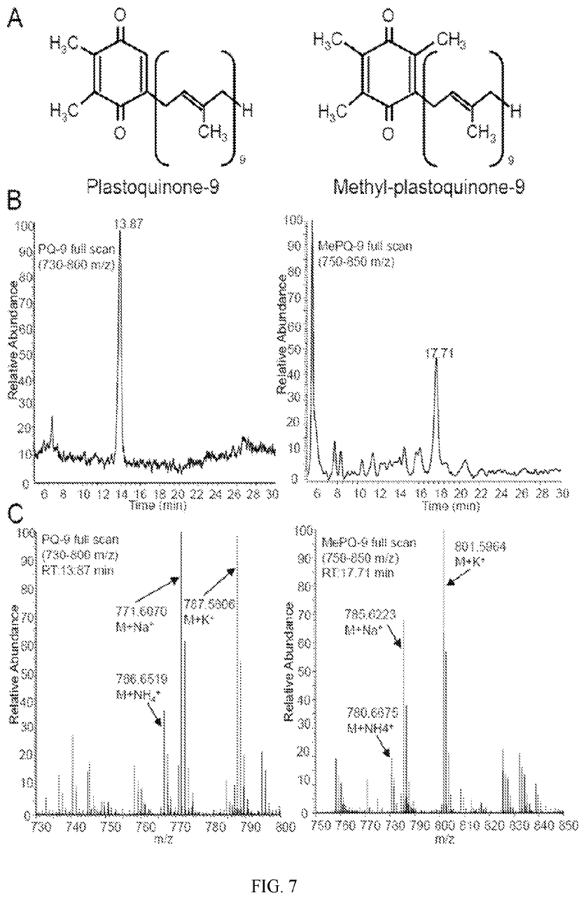

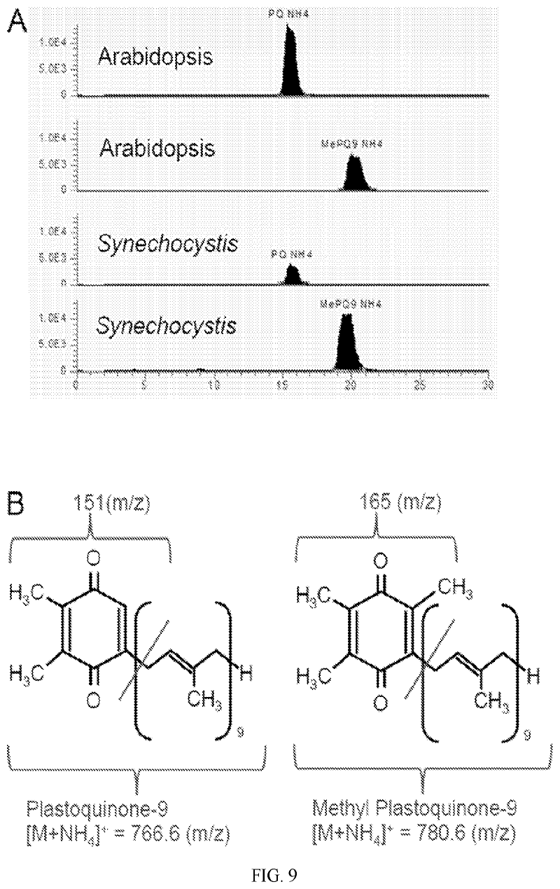

For quinone analyses in E. coli, cells (20 ml cultures) were grown at 37° C. in LB medium containing 0.2% arabinose as an inducer. Cells were harvested when cultures reached OD₆₀₀~1 and washed once with sterile water at 4° C. Final cell pellets were resuspended in 1 ml of sterile water, and cells were quantified by absorbance at 600 nm and then stored at −80° C. Disruption of thawed cells, phase partitioning of cell lysates, and analysis of corresponding extracts via reverse-phase HPLC coupled to diode array detection were performed as described in (Latimer S et al. “A dedicated flavin-dependent monooxygenase catalyzes the hydroxylation of demethoxyubiquinone into ubiquinone (coenzyme Q) in Arabidopsis.” J. Biol. Chem. 297, 101283 (2021)). Ubiquinone-8 (9.5 min) was monitored at 275 nm. Demethylmenaquinone-8 (12.4 min) and menaquinone-8 (14 min) were monitored at 248 nm. Quinols were fully converted into their quinone forms during extraction and were therefore not detected. For the analyses of prenylated quinones in Synechocystis, cells were scooped from plates, quantified and disrupted as described in (Fatihi A et al. 2015). Ethanol extracts of Arabidopsis leaf tissues (30-80 mg) were prepared as described in (Block A et al. “Functional modeling identifies paralogous solanesyl-diphosphate synthases that assemble the side chain of plastoquinone-9 in plastids.” J. Biol. Chem. 288, 27594-27606 (2013)). Benzoquinones were analyzed by reverse-phase HPLC as described in (28). Plastoquinol-9 (13.1 min), methyl-plastoquinol-9 (14.6 min) were monitored fluorimetrically (290 nm excitation/330 emission). Plastoquinone-9 (37 min) was monitored by absorbance at 255 nm. Methyl-plastoquinone-9 (44.3 min) was initially monitored by absorbance at 255 nm, and then quantified at 266 nm. Reverse-phase HPLC separation coupled to fluorometric detection (238 nm excitation/426 nm emission) after in-line reduction of demethylphylloquinone (14.5 min) and phylloquinone (17.3 min) was performed as described in (Widhalm J R et al. “A dedicated thioesterase of the Hotdog-fold family is required for the biosynthesis of the naphthoquinone ring of vitamin K1.” Proc. Natl. Acad. Sci. USA. 106, 5599-55603 (2009)). For liquid chromatography-mass spectrometry analyses, 2 μl of HPLC-purified quinone fractions were re-chromatographed on a Zorbax Eclipse Plus C18 column (2.1 mm×50 mm 1.8 micron; Agilent Technologies) held at 40° C. and developed isocratically with methanol containing 5 mM ammonium formate at a flow rate of 0.4 ml/min. Parent and daughter ions of plastoquinone-9 and methyl-plastoquinone-9 were analyzed in positive mode on a Thermo Q Exactive mass spectrometer (Thermo Scientific). Ammonium, sodium and potassium adducts of the intact compounds were identified using a full scan (730-800 m/z for plastoquinone; 750-850 m/z for methyl-plastoquinone-9) coupled with an all ion fragment scan at 13.87 min and 17.71 min respectively. Daughter ions for the ammonium adducts [M+NH4]⁺ were identified using single ion monitoring (SIM) coupled with data driven MS2 scans and a collision energy of 35 eV for plastoquinone-9 (766.654 m/z) and methyl-plastoquinone-9 (780.667 m/z) (FIGS. 7, 8, 9). For tandem mass spectrometry experiments, the eluate was electrosprayed in positive mode with nitrogen gas at 300° C., capillary voltage of 4000V, and collision energy of 20V, into a Thermo TQS Quantis mass spectrometer (Thermo Scientific). Compounds were monitored using single reaction monitoring of the [M+NH4]⁺ ions; plastoquinone-9 (766.6/151) and methyl-plastoquinone-9 (780.6/165) eluted at 15.5 min and 19.4 min, respectively.

### Example 1—Quinone C-Methyltransferases of Plastids and Mitochondria Display Strict Phylogenetic Segregation

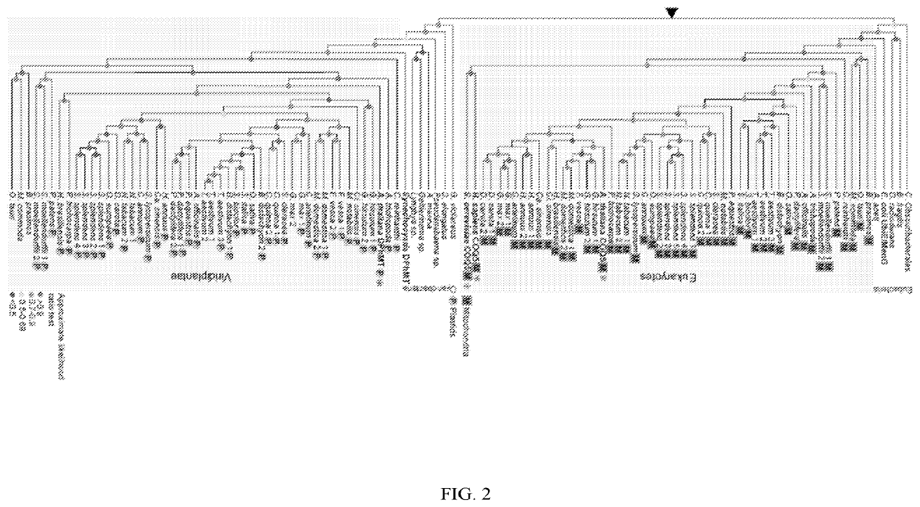

A survey of fully sequenced genomes sampled throughout Angiosperms, Lycophytes, Bryophytes, and Chlorophytes showed that the corresponding taxa all harbored at least two close homologs of prokaryotic UbiE/MenG, and that these proteins clustered in two phylogenetic clades (FIG. 2; Table 2 above). The first clade includes orthologs of Arabidopsis, human and yeast COQ5 proteins and some UbiE/MenG proteins from eubacteria, excluding cyanobacteria (FIG. 2). The second clade is comprised exclusively of plant and cyanobacterial proteins and includes experimentally confirmed DPhQ-MT from Arabidopsis and Synechocystis sp. PCC 6803 (FIG. 2). Emergence of paralogs is frequent in both clades (FIG. 2). Overlaying known and predicted subcellular localizations onto this phylogenetic reconstruction indicated that all the eukaryotic members from the first clade are targeted exclusively to the mitochondrion (FIG. 2; Table 2). In contrast, the majority of plant proteins from the second clade are either known (Arabidopsis) or predicted to be targeted to plastids (FIG. 2; Table 2 above). The few exceptions are three proteins from green algae (B. prasinos, M commoda, O. tauri) and four paralogs in Angiosperms (one each in tobacco and soybean, and two in wheat), for which no consensus subcellular targeting was found (FIG. 2; Table 2). For all Angiosperms, at least one paralog is predicted to be targeted to plastids (FIG. 2; Table 2). In the case of the three algal proteins, failure to robustly infer subcellular localization is likely attributable to algorithm bias: there is indeed evidence that sequence-based prediction tools, which have been predominantly trained with land plant proteins, fail to detect many plastid targeted proteins in Chlorophytes (Tardif M et al. “PredAlgo: a new subcellular localization prediction tool dedicated to green algae.” Mol. Biol. Evol. 29, 3625-3639 (2012)).

It therefore appears that, unlike bacteria, plants have evolved separate C-methyltransferases to synthesize their benzoquinones and naphthoquinones. Not only is the evolutionary scenario of a single quinone C-methyltransferase that is dual targeted to mitochondria and plastids never observed, but no clade 1 enzyme appears to be targeted to plastids and conversely no clade 2 enzyme appears to be targeted to mitochondria.

### Example 2—C-Methyltransferases have Evolved Unprecedented Substrate Specificity for Prenylated Naphthoquinols

Having shown that a hidden selection pressure operated throughout plant lineages to keep quinone C-methyltransferases of plastids evolutionarily and spatially separate from those of mitochondria, a sample of clade 1 and clade 2 enzymes were screened via functional complementation of an E. coli ΔubiE/menG knockout strain. This E. coli mutant is unable to catalyze the methylation of the biosynthetic intermediates of prenylated naphthoquinones and prenylated benzoquinones (FIG. 1), and therefore is devoid of menaquinone-8 and ubiquinone-8 (Table 1 above). Complementation with clade 1 enzymes from prokaryotes and truncated eukaryotic orthologs—i.e. without mitochondrial presequence-resulted in the production of menaquinone-8 and ubiquinone-8, while complementation with clade 2 enzymes from cyanobacteria and truncated plant orthologs—i.e. without plastid transit peptide-produced menaquinone-8 only (Table 1). No quinone formation was detected with the clade 1 orthologs of P. patens and M. commoda, or with the clade 2 orthologs of P. patens, O. tauri, and M. commoda indicating that these enzymes were not functional in E. coli (Table 1). These results demonstrate that cyanobacterial quinone C-methyltransferases and their plastid-targeted orthologs act on prenylated naphthoquinols, but not on prenylated benzoquinols. Also remarkable is the observation that the bi-functionality of clade 1 enzymes is independent of the type of prenylated quinones produced by the organism of origin. For instance, B. fragilis and D. radiodurans are exclusive menaquinone producers, while A. aceti produces exclusively ubiquinone (Collins M D et al. “Distribution of isoprenoid quinone structural types in bacteria and their taxonomic implication.” Microbiol. Rev. 45, 316-354 (1981)). Similarly, yeast and humans synthesize ubiquinone, but not menaquinone or phylloquinone.

### Example 3—COQ5 Expression in Cyanobacteria and COQ5-Retargeting to Plastids Results in Acute Cytotoxicity

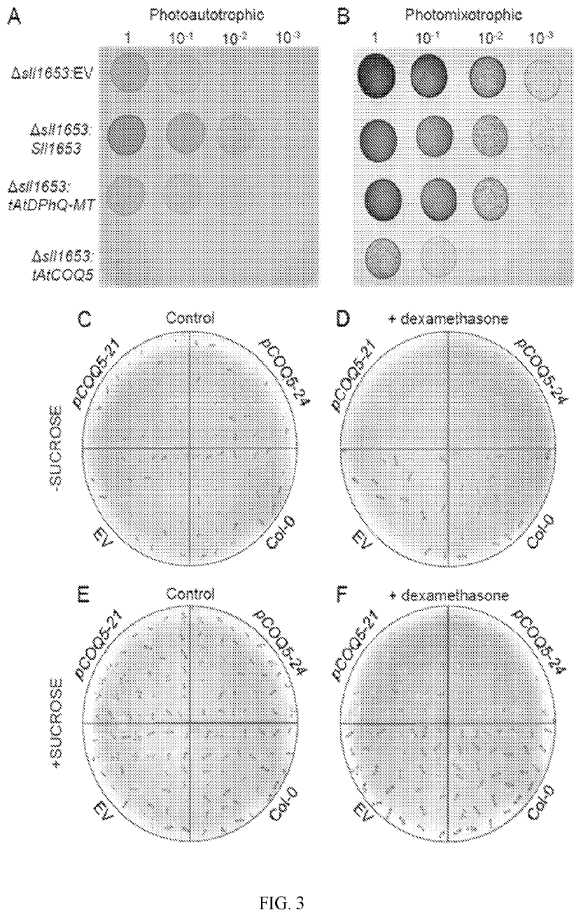

To further investigate why clade 2 C-methyltransferases evolved strict substrate preference, the effect of replacing cognate cyanobacterial and plastid-targeted DPhQ-MT with a bifunctional COQ5 counterpart was examined. To do that, a N-terminally truncated version of Arabidopsis COQ5 (tAtCOQ5) was first subcloned into cyanobacterial expression vector pSynExp-2 under the control of constitutive promoter psbA2. Native Synechocystis DPhQ-MT (Sll1653) and its N-terminally truncated Arabidopsis ortholog (tAtDPhQ-MT) served as positive controls, and empty pSynExp-2 as the negative control. These constructs were then introduced into a Synechocystis DPhQ-MT knockout strain and the growth of individual clones was scored via serial dilution assays (FIG. 3 A-B). In photoautotrophic conditions, barely any growth was observed for the COQ5-harboring cells even after three weeks of incubation (FIG. 3A). After 8-10 weeks of incubation, fast-growing colonies appeared in the corresponding inocula; sequencing of the COQ5 insert in three of these colonies revealed the presence of either deletions in a COQ5/UbiE signature domain (IPRO23576) or of a single base insertion resulting in an early stop codon. When cells were cultured photomixotrophically, growth of the COQ5 transformant was readily observed, but still displayed major delay as compared to that of control strains (FIG. 3B).

In parallel, an Arabidopsis COQ5 cDNA, the mitochondrial presequence of which had been swapped for a plastid transit peptide (pCOQ5), was placed under the control of a dexamethasone-inducible promoter, and this construct was introduced into an Arabidopsis DPhQ-MT T-DNA knockout. When sowed on control plates, T3 seeds homozygous for the COQ5 transgene (lines pCOQ5-21 and pCOQ5-24) germinated and developed similarly to the empty vector and wild-type control seedlings (FIG. 3C, E). In contrast, on dexamethasone-containing plates without sucrose, COQ5 transgenics were fully chlorotic and stopped growing immediately after emergence of the cotyledons (FIG. 3D). These developmental defects were attenuated when sucrose was added to the culture medium (FIG. 3F). No difference in phenotype and growth was observed between control and dexamethasone-containing plates for the empty vector and wild-type controls (FIG. 3C, D, E, F). These data demonstrate that replacing mono-functional DPhQ-MT with bi-functional COQ5 in cyanobacteria and plastids markedly impairs cell growth and viability. Furthermore, that the exogenous supply of carbohydrates mitigates such developmental defects suggests that COQ5 expression is linked to impaired photosynthesis.

### Example 4—COQ5-Harboring Synechocystis and Arabidopsis Transgenics Accumulate a New-to-Nature Methylated Form of Plastoquinone

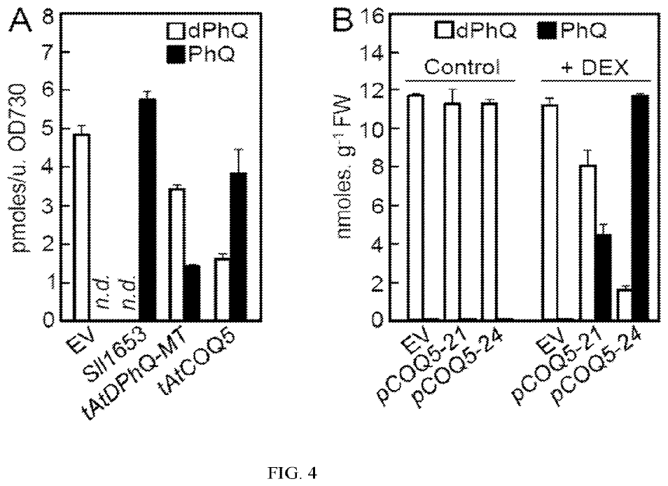

Metabolite profiling targeted to vital photosynthetic quinones readily detected phylloquinone in the Synechocystis and soil-grown Arabidopsis DPhQ-MT knockouts that expressed COQ5, verifying that truncated COQ5 and plastid-targeted COQ5 versions were indeed catalytically active (FIG. 4A, B). Conversion of demethylphylloquinone into phylloquinone represented ~70% of the total naphthoquinone pool in Synechocystis COQ5 transformants, and ~37% (line COQ5-21) to ~88% (line COQ5-24) in their Arabidopsis counterparts (FIG. 4A, B). As expected, phylloquinone was not detected in either of the vector alone controls or in the plants treated with the control spray (FIG. 4A, B).

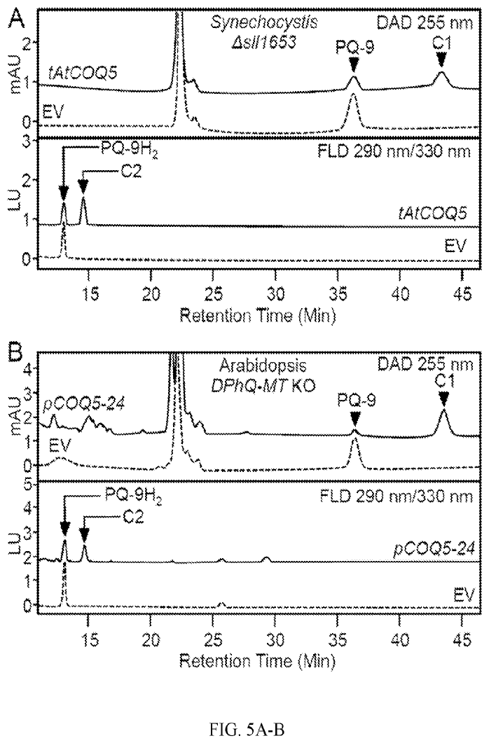

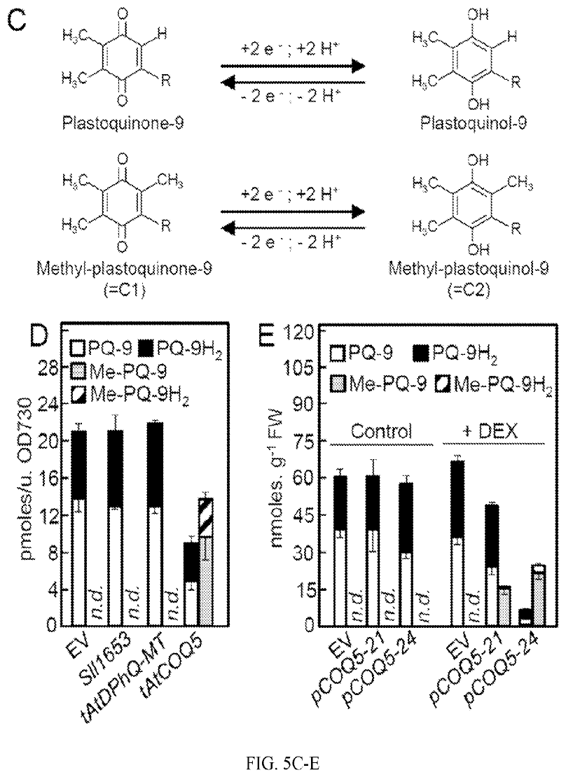

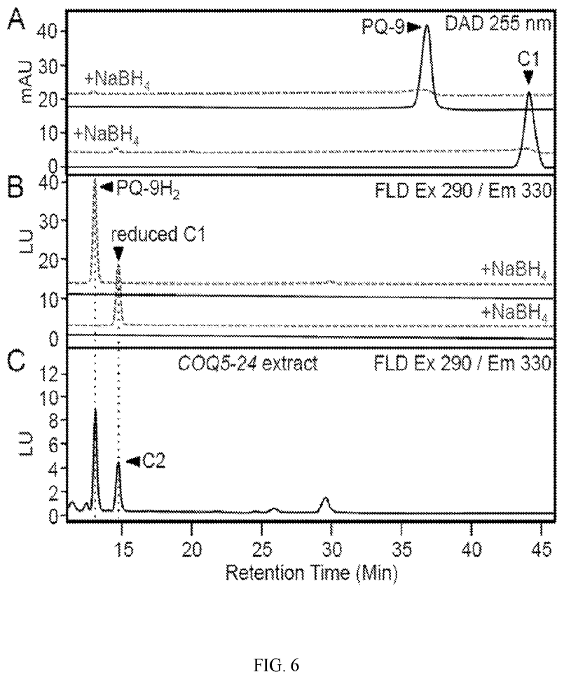

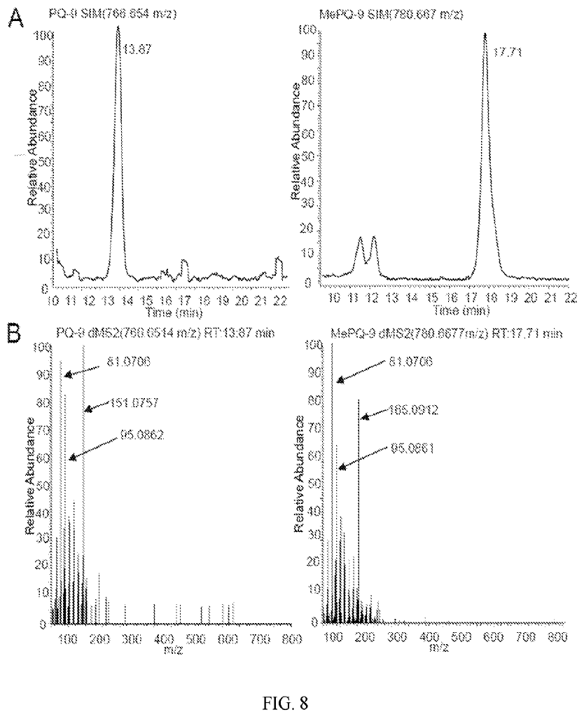

Two unknown compounds, absent from either of the vector alone controls, were detected in the extracts of COQ5-expressing Synechocystis cells and Arabidopsis leaves (dexamethasone-treated line COQ5-24) (FIG. 5A, B). The first compound (44.3 min) was detected via diode-array spectrophotometry adjacent to plastoquinone-9 (37 min), while the second compound (14.6 min) was detected fluorometrically, adjacent to plastoquinol-9 (13.1 min), the reduced form of plastoquinone-9 (FIG. 4A, B). When HPLC-purified compound 1 was treated with sodium borohydride and then re-chromatographed, its retention time was shifted to that of compound 2 and reduced compound 1 acquired the same fluorescent characteristics as compound 2, demonstrating that the compounds 1 and 2 obeyed the same redox chemistry as plastoquinone-9 and plastoquinol-9 (FIG. 6). Given the catalytic promiscuity of COQ5 and the structural similarity between plastoquinone-9 (FIG. 5C) and COQ5's native benzoquinone substrate (FIG. 1A), we inferred that compounds 1 and 2 likely corresponded to the methylated variants of plastoquinone-9 and plastoquinol-9 (FIG. 5C). High-resolution LC-MS and targeted LC-MS/MS analyses confirmed that the masses of the parent and ring-containing product ions corresponding to compound 1 extracted from Synechocystis and Arabidopsis were indeed identical to those predicted for methyl-plastoquinone-9 (FIGS. 8-10). Methyl-plastoquinone-9 and methyl-plastoquinol-9 were detected exclusively in the Synechocystis COQ5 transformants and dexamethasone-treated Arabidopsis COQ5 transgenics (FIG. 5D, E). The accumulation of these methylated variants paralleled that of phylloquinone (FIG. 4A, B), and was inversely correlated with the levels of plastoquinone-9 and plastoquinol-9 representing ~54% of the total benzoquinone pool in Synechocystis, and ~25% (line COQ5-21) to ~80% (line COQ5-24) in Arabidopsis (FIG. 5D, E). In contrast to plastoquinone-9, the oxidation level of which never exceeded ~60% in Arabidopsis leaves, methyl-plastoquinone-9 occurred predominantly in its oxidized form (83% and 92% oxidation in lines COQ5-21 and COQ5-24, respectively) indicating that the contribution of this methyl variant to the reactions of oxidoreduction in vivo is marginal (FIG. 5D, E).

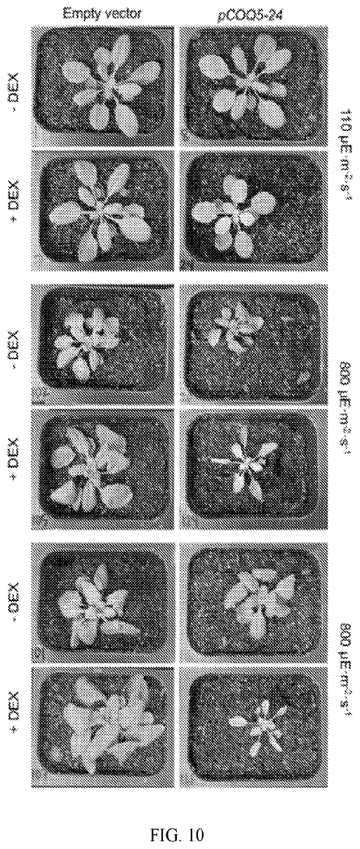

Four days after dexamethasone induction, transgenics from line COQ5-24, which displayed the largest conversion of plastoquinone-9 into methyl-plastoquinone-9, developed a marked bleaching phenotype at the center of the rosette (FIG. 10). Imaging of chlorophyll a fluorescence and calculation of associated photosynthetic parameters indicated a collapse of maximum quantum efficiency of photosystem II in dexamethasone-treated COQ5-24 plants resulting in ~50% photoinhibition (Table 3). Net CO₂ assimilation, which correlates with variable fluorescence decrease ratio (Lichtenthaler H K et al. “Fluorescence imaging as a diagnostic tool for plant stress.” Trends Plant Sci. 2, 316-320 (1997)), as well as the ability to mitigate excess excitation energy via non-photochemical quenching (Müller P et al. “Non-photochemical quenching. A response to excess light energy.” Plant Physiol. 125, 1558-1566 (2001)), was also markedly decreased in the induced COQ5-24 transgenics (Table 3).

TABLE 3
Fluorescence parameters of Arabidopsis transgenics.

| | Fluorescence | | |
|---|---|---|---|
| Growth Condition | Parameters | Empty vector | pCOQ5-24 |
| 110 μE m⁻² | Fv/Fm | 0.83 ± 0 | 0.83 ± 0 |
| s⁻¹ − DEX | R_{fd} | 1.12 ± 0.04 | 1.13 ± 0.03 |
| | NPQ | 0.46 ± 0.02 | 0.46 ± 0.02 |
| 110 μE m⁻² | Fv/Fm | 0.83 ± 0 | 0.75 ± 0.01* |
| s⁻¹ + DEX | R_{fd} | 1.11 ± 0.03 | 0.39 ± 0.04* |
| | NPQ | 0.46 ± 0.01 | 0.1 ± 0.01* |
| | Photoinhibition (%) | 0 | 10 ± 1** |
| 800 μE m⁻²s⁻¹ | Fv/Fm | 0.82 ± 0 | 0.82 ± 0 |
| (72 h) − DEX | R_{fd} | 0.27 ± 0.02 | 0.28 ± 0.01 |
| | NPQ | 0.21 ± 0.01 | 0.23 ± 0.01 |
| 800 μE m⁻²s⁻¹ | Fv/Fm | 0.82 ± 0 | 0.26 ± 0.04* |
| (72 h) + DEX | R_{fd} | 0.26 ± 0.02 | 0.14 ± 0.02* |
| | NPQ | 0.20 ± 0.01 | 0.15 ± 0.02* |
| | Photoinhibition (%) | 0 | 68 ± 5** |
| 800 μE m⁻²s⁻¹ | Fv/Fm | 0.83 ± 0 | 0.83 ± 0 |
| (120 h) − DEX | R_{fd} | 0.38 ± 0.02 | 0.38 ± 0.02 |
| | NPQ | 0.23 ± 0.01 | 0.23 ± 0.01 |
| 800 μE m⁻²s⁻¹ | Fv/Fm | 0.83 ± 0 | — |
| (120 h) + DEX | R_{fd} | 0.35 ± 0.02 | — |
| | NPQ | 0.24 ± 0.01 | — |
| | Photoinhibition (%) | 0 | — |

Maximum quantum efficiencies (Fv/Fm), variable fluorescence decrease ratios (R_{fd}), non-photochemical quenching (NPQ) values, and percentages of photoinhibition in dexamethasone-induced (+DEX) plants versus non-induced controls (−DEX) were calculated from 20 measurements from four biological replicates ±SE. Single asterisks indicate significant differences from the corresponding non-induced plants as determined by Fisher's test (p<α=0.05) from an analysis of variance. For photoinhibition, double asterisks indicate significant differences from the corresponding empty-vector control as determined by Fisher's test (p<α=0.05) from an analysis of variance.

### Example 5—Methylated Quinone Derivatives as Potent Inhibitors of Photosynthesis

Described herein is the existence of a selection pressure that drives in cyanobacteria and plastids the evolution of quinone C-methyltransferases with strict specificity for demethylnaphthoquinol substrates. In contrast, UbiE/COQ5 homologs, whose taxonomic distribution is near universal, are active with both demethylnaphthoquinol and benzoquinol substrates, irrespective of the quinone profile of their host organisms. From an evolutionary perspective, these findings are congruent with the observation that promiscuous enzymes tend to be uniformly distributed throughout the Tree of Life, while highly specific enzymes usually cluster in discrete lineages (Carbonell P et al. 2011). In terms of catalytic mechanism, plant and cyanobacterial demethylnaphthoquinol methyltransferases, which have no wobble for substrate preference, thus represent instances of evolutionary termini in the quinone C-methyltransferase family.

Phylogenetic reconstructions and functional complementation assays indicate that mono-functional naphthoquinol methyltransferases most likely emerged in cyanobacteria, and that plastid-targeted orthologs are without exception of cyanobacterial descent (FIG. 2; Table 1). The finding that C. Obscuribacteriales bacterium, a member of the phylum of non-photosynthetic bacteria (Melainabacteria) most closely related to cyanobacteria (Di Rienzi S C et al. “The human gut and groundwater harbor non-photosynthetic bacteria belonging to a new candidate phylum sibling to Cyanobacteria.” Elife. 2, e01102 (2013)), harbors a bi-functional clade 1 quinone C-methyltransferase and no mono-functional clade 2 ortholog validates this scenario (FIG. 2; Table 1).

The above results also demonstrate that in cyanobacteria and plastids the evolution and retention of mono-functional demethylnaphthoquinol methyltransferases is driven by the spatial co-occurrence of two vital redox cofactors. The first one is a prenylated naphthoquinone (phylloquinone or menaquinone depending on the organism) that functions as the electron acceptor A₁ of photosystem I. The presence of a methyl group on C2 of the naphthalene ring—i.e. ortho of the prenyl chain (FIG. 1)—has been shown to be required for optimal photosynthetic activity (Lohmann A et al. 2006 and Fatihi A et al. 2015). The second redox cofactor, plastoquinone-9, is a prenylated benzoquinone that serves multiple roles associated with photosynthesis, including electron transfer between photosystem II and cytochrome b6/f proton translocation through thylakoidal membranes, chlororespiration, cyclic electron flow, phytoene desaturation, redox sensing and signaling, and ROS scavenging (Havaux M “Plastoquinone In and Beyond Photosynthesis.” Trends Plant Sci. 25, 1252-1265(2020)). Importantly, unlike phylloquinone, menaquinone or ubiquinone, plastoquinone-9 lacks a methyl group on the carbon ortho of the prenyl chain (FIG. 5C). Expression of bi-functional COQ5 in cyanobacteria or its re-targeting to plastids results in the methylation of plastoquinone-9 at this ring position. Accumulation of methyl-plastoquinone-9 is acutely toxic, especially when transformants are cultured photoautotrophically: Synechocystis clones eventually evolve suppressor mutations in the COQ5 gene, and dexamethasone-induced Arabidopsis transgenics are seedling lethal. These findings explain why in eukaryotes the phylogenetic signals of quinone C-methyltransferases rigidly track the target organelles of these enzymes, and why plants in particular cannot capture the intrinsic bi-functionality of UbiE/COQ5 to synthesize simultaneously naphthoquinones and benzoquinones, as some prokaryotes do.

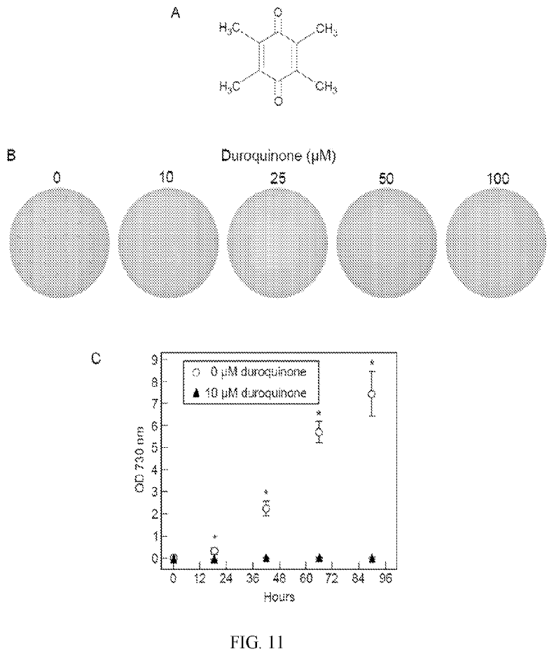

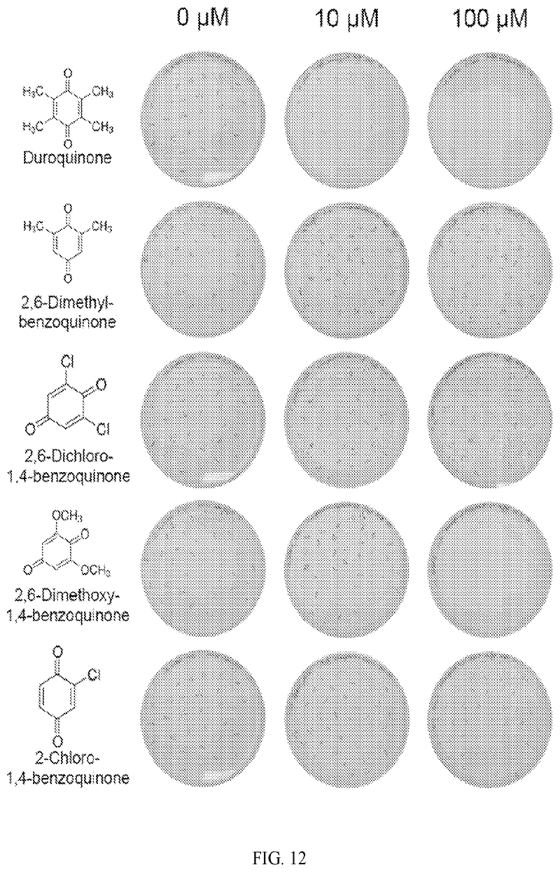

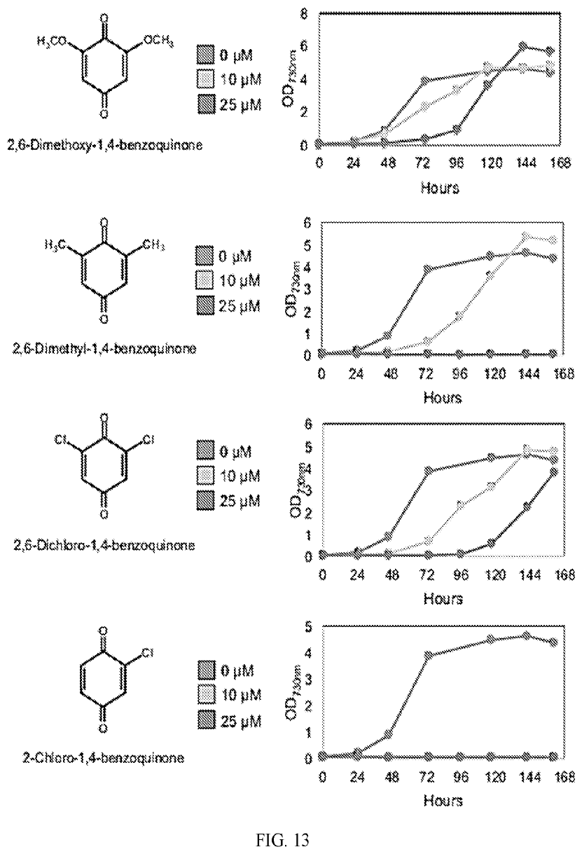

In Arabidopsis leaf tissues, methyl-plastoquinone-9 occurs almost exclusively in its oxidized form, in sharp contrast with the high quinol/quinone ratio that typifies the pool of photoactive plastoquinone-9 (Block A et al. 2013). This result strongly suggests that methyl-plastoquinone-9 is not functional as an electron carrier for photosynthesis, and measurements of chlorophyll a fluorescence emission show indeed that expression of plastid-targeted COQ5 triggers a pronounced drop of the maximum quantum efficiency of photosystem II. There are indications, however, that the phenotypic defects associated with the accumulation of methyl-plastoquinone-9 go beyond the mere depletion of the photoactive pool of plastoquinone-9. Indeed, Arabidopsis solanesyl-diphosphate synthase mutants, for which loss of plastoquinone-9 is similar to that measured in the COQ5 transgenics, do not display any growth defects or impaired photosynthetic activity, at least when grown in a standard light regime (Block A et al. 2013). It is therefore highly probable that methyl-plastoquinone-9 is itself cytotoxic, for instance by acting as a competitive inhibitor of plastoquinone-9 (e.g. QA binding site of photosystem II, NADPH dehydrogenase complex, plastid terminal oxidase). The situation is likely compounded in cyanobacteria, where plastoquinone-9 doubles as an electron carrier of the respiratory chain (Cooley J W et al. “Succinate dehydrogenase and other respiratory pathways in thylakoid membranes of Synechocystis sp. strain PCC 6803: capacity comparisons and physiological function.” J. Bacteriol. 183, 4251-4258 (2011)). From a biotechnology perspective, the discovery that methyl-plastoquinone-9 acts as a potent inhibitor of photosynthesis opens a new avenue for the development of novel herbicides. Supporting this idea, it was found that duroquinone, the unprenylated version of methyl-plastoquinone-9, displayed marked toxicity in Arabidopsis even when applied at 2 to 50 times lower concentrations than that used for standard herbicides such as DCMU or glyphosate (FIGS. 11A and 11B) (Chen G H et al. “TOR and RPS6 transmit light signals to enhance protein translation in deetiolating Arabidopsis seedlings.” Proc. Natl. Acad. Sci. USA. 115, 12823-12828 (2018); Klee H J et al. “Cloning of an Arabidopsis thaliana gene encoding 5-enolpyruvylshikimate-3-phosphate synthase: sequence analysis and manipulation to obtain glyphosate-tolerant plants.” Mol. Gen. Genet. 210, 437-442 (1987)). Structural analogues of methyl-plastoquinone were also tested as potential growth inhibitors for cyanobacteria. The compounds tested include 2,6-dimethoxy-1,4-benzoquinone, 2,6-dimethyl-1,4-benzoquinone, 2,6-dichloro-1,4-benzoquinone, and 2-chloro-1,4-benzoquinone. As shown in FIGS. 12 and 13, 2-chloro-1,4-benzoquinone is as effective as duroquinone for growth inhibition of Synechocystis sp. PCC6803 cells (i.e. complete growth inhibition as both 10 microM and 25 microM). Whereas, 2,6-dimethyl-1,4-benzoquinone displays intermediate inhibitory activity (i.e. complete growth inhibition only at 25 microM) and 2,6-dimethoxy-1,4-benzoquinone and 2,6-dichloro-1,4-benzoquinone display low to marginal inhibitory activity.

### Example 6-Methylplastoquinone Analogues as Inhibitors of Photosynthesis

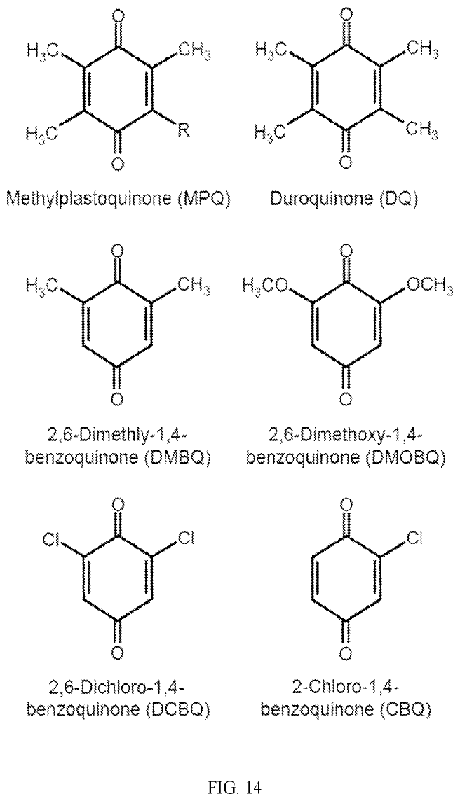

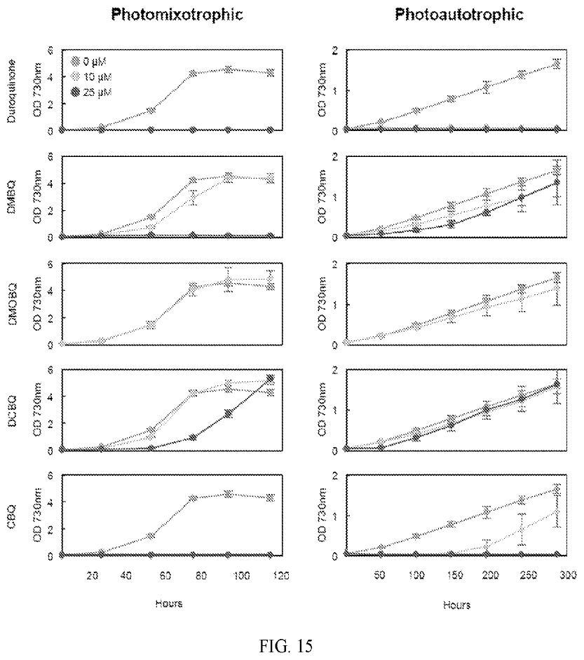

Several analogues of Methylplastoquinone (FIG. 14) were tested for their ability to act as herbicides. Synechocystis were grown photomixotrophically (BG-11 plus 5 mM glucose) and photoautotrophically (BG-11 without glucose) at a continuous light intensity of 50μ photons m⁻²s⁻¹ at 30° C. with shaking 125 rpm. The cultures were further treated with 0, 10, or 25 μM Doruquinone (DQ), 2,6-dimethly-1,4-benzoquinone (DMBQ), 2,6-dimethoxy-1,4-benzoquinone (DMOBQ), 2,6-dichloro-1,4-benzoquinone (DCBQ), or 2-chloro-1,4-benzoquinone (CBQ), each with 0.0.95% ethanol. Effect on growth is shown in FIG. 15.

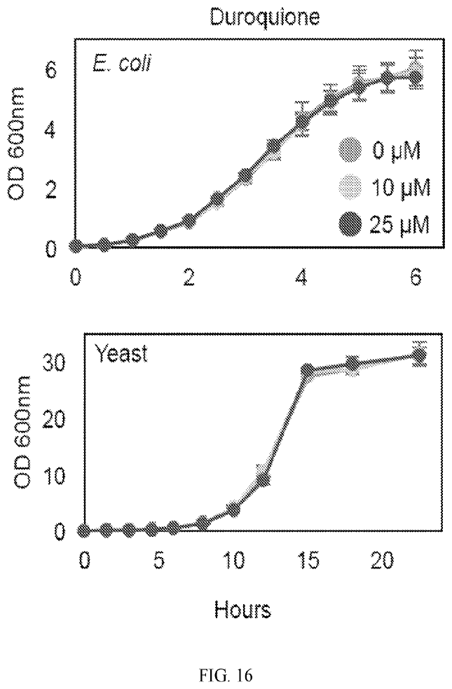

E. coli and yeast were grown in LB at 37° C. and YPD at 30° C., respectively. The cultures were then treated with 0, 10 or 25 μM duroquinone. The effect of duroquinone on the growth of E. coli and yeast are shown in FIG. 16.

Arabidopsis were grown by structural analogues of methyl-plastoquinone-9.

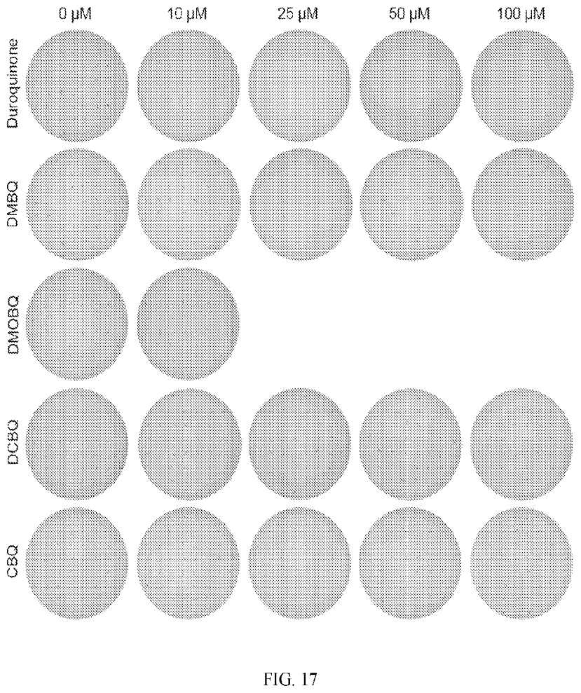

Ten day-old Arabidopsis plants (Col-0) were grown on MS medium containing 1% sucrose (w/v), 0.095% EtOH, and 0, 10, 25, 50 or 100 μM methyl-plastoquinone analogues in 12-h days (photon flux of 110 μmol m⁻²s⁻¹) at 22° C. The effect of the analogs on growth is shown in FIG. 17.

Efforts have been made to ensure accuracy with respect to numbers used (e.g., amounts, temperature, etc.) but some experimental errors and deviations should be accounted for.

One skilled in the art will recognize many methods and materials similar or equivalent to those described herein, which could be used in the practicing the subject matter described herein. The present disclosure is in no way limited to just the methods and materials described.

Unless defined otherwise, technical, and scientific terms used herein have the same meaning as commonly understood by one of ordinary skill in the art to which this subject matter belongs.

Throughout this specification and the claims, the words “comprise,” “comprises,” and “comprising” are used in a non-exclusive sense, except where the context requires otherwise. It is understood that embodiments described herein include “consisting of” and/or “consisting essentially of” embodiments.

Where a range of values is provided, it is understood that each intervening value, to the tenth of the unit of the lower limit, unless the context clearly dictates otherwise, between the upper and lower limit of the range and any other stated or intervening value in that stated range, is encompassed. The upper and lower limits of these small ranges which may independently be included in the smaller rangers is also encompassed, subject to any specifically excluded limit in the stated range. Where the stated range includes one or both of the limits, ranges excluding either or both of those included limits are also included.

Many modifications and other embodiments set forth herein will come to mind to one skilled in the art to which this subject matter pertains having the benefit of the teachings presented in the foregoing descriptions and the associated drawings. Therefore, it is to be understood that the subject matter is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of inhibiting photosynthesis in a prokaryotic or eukaryotic organism capable of photosynthesis, wherein the method comprises:
contacting the prokaryotic or eukaryotic organism capable of photosynthesis with an effective amount of a herbicide compound comprising a compound of Formula I: 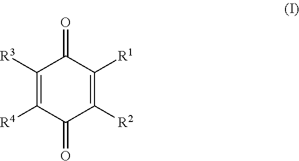
wherein,
R¹ is halogen, C₁-C₆ alkyl, C₁-C₆ alkoxy, or substituted C₁-C₆ alkyl;
R² is selected from the group consisting of: H, C₁-C₆ alkyl, substituted C₁-C₆ alkyl, C₂-C₅₀ alkenyl, and substituted C₂-C₅₀ alkenyl; and
R³ and R⁴ are each independently selected from the group consisting of: H, halogen, C₁-C₆ alkyl, substituted C₁-C₆ alkyl, C₁-C₆ alkoxy, substituted C₁-C₆ alkoxy, cycloalkyl, substituted cycloalkyl, heterocyclyl, substituted heterocycloalkyl, aryl, substituted aryl, heteroaryl, and substituted heteroaryl; or
R³ and R⁴ together with the carbon atoms to which each is attached can come together to form a ring selected from the group consisting of C₃-C₁₀ cycloalkyl, substituted C₃-C₁₀ cycloalkyl, C₅-C₁₀ aryl, substituted C₅-C₁₀ aryl, C₃-C₁₀ heterocycloalkyl, substituted C₃-C₁₀ heterocycloalkyl, C₅-C₁₀ heteroaryl, and substituted C₅-C₁₀ heteroaryl.

2. The method of claim 1, wherein R¹ is selected from the group consisting of methyl, ethyl, propyl, isopropyl, butyl, sec-butyl, tert-butyl, pentyl, and hexyl.

3. The method of claim 1 or 2, wherein R¹ is methyl.

4. The method of any one of claims 1-3, wherein R² is C₁-C₆ alkyl or substituted C₁-C₆ alkyl.

5. The method of claim 4, wherein R² is selected from the group consisting of methyl, ethyl, propyl, isopropyl, butyl, sec-butyl, tert-butyl, pentyl, and hexyl.

6. The method of any one of claims 1-3, wherein R² is C₂-C₅₀ alkenyl or substituted C₂-C₅₀ alkenyl.

7. The method of claim 6, wherein R² is C₂-C₅₀ alkenyl substituted with one or more substituents selected from the group consisting of halogen, C₁-C₆ alkyl, and C₁-C₆ alkoxy.

8. The method of claim 7, wherein the one or more substituents is C₁-C₆ alkyl.

9. The method of claim 8, wherein the one or more substituents is methyl.

10. The method of any one of claims 6-9, wherein R² is selected from the group consisting of isoprenyl, geranyl, farnesyl, geranylgeranyl, gernaylfarnesyl, hexaprenyl, heptaprenyl, octaprenyl, solanesyl, and decaprenyl.

11. The method of claim 10, wherein R² is selected from the group consisting of octaprenyl, solanesyl, and decaprenyl.

12. The method of claim 11, wherein R² is solanesyl.

13. The method of any one of claims 1-12, wherein R³ and R⁴ are each independently selected from the group consisting of halogen, C₁-C₆ alkyl, substituted C₁-C₆ alkyl, C₁-C₆ alkoxy, and substituted C₁-C₆ alkoxy.

14. The method of claim 13, wherein R³ and R⁴ are each independently C₁-C₆ alkyl or substituted C₁-C₆ alkyl.

15. The method of claim 14, wherein R³ and R⁴ are each independently selected from methyl, ethyl, propyl, isopropyl, butyl, sec-butyl, tert-butyl, pentyl, and hexyl.

16. The method of claim 15, wherein R³ and R⁴ are methyl.

17. The method of any one of claims 1-12, wherein R³ and R⁴ and the carbon atoms to which each is attached come together to form a ring.

18. The method of claim 17, wherein the ring is selected from the group consisting of aryl, substituted aryl, heteroaryl, and substituted heteroaryl.

19. The method of claim 18, wherein the ring is aryl or substituted aryl.

20. The method of claim 19, wherein the ring is optionally substituted phenyl.

21. The method of any one of claims 1-20, wherein the inhibition of photosynthesis inhibits growth of prokaryotic or eukaryotic organism capable of photosynthesis.

22. The method of claim 21, wherein growth of the prokaryotic or eukaryotic organism capable of photosynthesis is inhibited by about 50% to about 100%.

23. The method of claim 22, wherein growth of the prokaryotic or eukaryotic organism capable of photosynthesis is inhibited by about 85%, 86%, 87%, 88%, 89%, 90%, 91%, 92%, 93%, 94%, 95%, 96%, 97%, 98%, 99%, or 100%.

24. The method of any one of claims 21-23, wherein growth of the prokaryotic or eukaryotic organism capable of photosynthesis is inhibited by greater than 95%.

25. The method of any one of claims 1-24, wherein the prokaryotic or eukaryotic organism capable of photosynthesis is a eukaryotic organism.

26. The method of claim 25, wherein the eukaryotic organism is a plant.

27. The method of any one of claims 1-24, wherein the prokaryotic or eukaryotic organism capable of photosynthesis is a prokaryotic organism.

28. The method of claim 27, wherein the prokaryotic organism is a cyanobacteria.

29. A method of inhibiting growth of a plant comprising:
contacting the plants with an effective amount of an herbicide compound comprising a compound of Formula I: 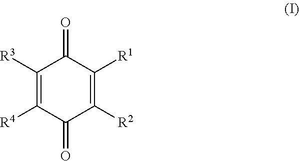
wherein,
R¹ is halogen, C₁-C₆ alkyl, C₁-C₆ alkoxy, or substituted C₁-C₆ alkyl;
R² is selected from the group consisting of: H, C₁-C₆ alkyl, substituted C₁-C₆ alkyl, C₂-C₅₀ alkenyl, and substituted C₂-C₅₀ alkenyl; and
R³ and R⁴ are each independently selected from the group consisting of H, halogen, C₁-C₆ alkyl, substituted C₁-C₆ alkyl, C₁-C₆ alkoxy, substituted C₁-C₆ alkoxy, cycloalkyl, substituted cycloalkyl, heterocyclyl, substituted heterocycloalkyl, aryl, substituted aryl, heteroaryl, and substituted heteroaryl; or
R³ and R⁴ together with the carbon atoms to which each is attached can come together to form a ring selected from the group consisting of C₃-C₁₀ cycloalkyl, substituted C₃-C₁₀ cycloalkyl, C₅-C₁₀ aryl, substituted C₅-C₁₀ aryl, C₃-C₁₀ heterocycloalkyl, substituted C₃-C₁₀ heterocycloalkyl, C₅-C₁₀ heteroaryl, and substituted C₅-C₁₀ heteroaryl.

30. The method of claim 29, wherein R¹ is selected from the group consisting of methyl, ethyl, propyl, isopropyl, butyl, sec-butyl, tert-butyl, pentyl, and hexyl.

31. The method of claim 29 or 30, wherein R¹ is methyl.

32. The method of any one of claims 29-31, wherein R² is C₁-C₆ alkyl or substituted C₁-C₆ alkyl.

33. The method of claim 32, wherein R² is selected from the group consisting of methyl, ethyl, propyl, isopropyl, butyl, sec-butyl, tert-butyl, pentyl, and hexyl.

34. The method of any one of claims 29-31, wherein R² is C₂-C₅₀ alkenyl or substituted C₂-C₅₀ alkenyl.

35. The method of claim 34, wherein R² is C₂-C₅ alkenyl substituted with one or more substituents selected from the group consisting of halogen, C₁-C₆ alkyl, and C₁-C₆ alkoxy.

36. The method of claim 35, wherein the one or more substituents is C₁-C₆ alkyl.

37. The method of claim 36, wherein the one or more substituents is methyl.

38. The method of any one of claims 34-37, wherein R² is selected from the group consisting of isoprenyl, geranyl, farnesyl, geranylgeranyl, gernaylfarnesyl, hexaprenyl, heptaprenyl, octaprenyl, solanesyl, and decaprenyl.

39. The method of claim 38, wherein R² is selected from the group consisting of octaprenyl, solanesyl, and decaprenyl.

40. The method of claim 39, wherein R² is solanesyl.

41. The method of any one of claims 29-40, wherein R³ and R⁴ are each independently selected from the group consisting of halogen, C₁-C₆ alkyl, substituted C₁-C₆ alkyl, C₁-C₆ alkoxy, and substituted C₁-C₆ alkoxy.

42. The method of claim 41, wherein R³ and R⁴ are each independently C₁-C₆ alkyl or substituted C₁-C₆ alkyl.

43. The method of claim 42, wherein R³ and R⁴ are each independently selected from methyl, ethyl, propyl, isopropyl, butyl, sec-butyl, tert-butyl, pentyl, and hexyl.

44. The method of claim 43, wherein R³ and R⁴ are methyl.

45. The method of any one of claims 29-40, wherein R³ and R⁴ and the carbon atoms to which each is attached come together to form a ring.

46. The method of claim 45, wherein the ring is selected from the group consisting of aryl, substituted aryl, heteroaryl, and substituted heteroaryl.

47. The method of claim 46, wherein the ring is aryl or substituted aryl.

48. The method of claim 47, wherein the ring is optionally substituted phenyl.

49. The method of any one of claims 29-48, wherein growth of the plant is inhibited by about 50% to about 100%.

50. The method of claim 49, wherein growth of the plant is inhibited by about 85%, 86%, 87%, 88%, 89%, 90%, 91%, 92%, 93% 94% 95%, 96%, 97%, 98%, 99%, or 100%.

51. The method of any one of claims 49 or 50, wherein growth of the organism is inhibited by greater than 95%.

52. The method of any one of claims 29-51, wherein the plant is in a crop field.

53. An herbicidal compound comprising the following structure:

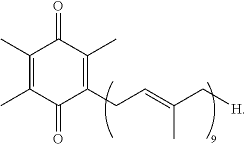

54. A method of inhibiting photosynthesis in a prokaryotic or eukaryotic organism capable of photosynthesis, wherein the method comprises: contacting the prokaryotic or eukaryotic organism capable of photosynthesis with an effective amount of an herbicidal compound of claim 53.

55. A method of inhibiting growth of a plant, wherein the method comprises: contacting the plant with an effective amount of the herbicidal compound of claim 53.
